(19) United States
(12) Patent Application Publication
(10) Pub. No.: US 2012/0069894 A1
(43) Pub. Date: Mar. 22, 2012

(54) Method Of Transmitting Video Data

(76) Inventors: Toshio Sakimura, Osaka (JP); Akihiro Tatsuta, Kyoto (JP); Makoto Funabiki, Osaka (JP); Hiroshi Ohue, Osaka (JP)

(21) Appl. No.: 13/375,354

(22) PCT Filed: Dec. 24, 2009
(86) PCT No.: PCT/JP2009/007190

§ 371 Date: Nov. 30, 2011

(30) Foreign Application Priority Data
Jun. 1, 2009 (JP) 2009-132054
Sep. 11, 2009 (JP) 2009-210388

(51) Int. Cl. H04N 7/12

(52) U.S. Cl. 375/240.02; 375/E07.126

(57) ABSTRACT

A sink device wirelessly transmits a device capability response message to a source device. The device capability response message includes a video information message including at least one video format identification code (VIC) for identifying a video format of video data, which the sink device can display, and a coded video information message including compressing parameters for compressing video data. The VIC includes a VIC for 4k2k video data having 3840 or 4096 effective horizontal pixels and 2160 effective vertical pixels.

### TECHNICAL FIELD

The present invention relates to a method of transmitting video data, a source device for transmitting the video data, a sink device for receiving the video data, and a wireless communication system including the source device and the sink device. In particular, the present invention relates to a method of transmitting video data for wirelessly transmitting video data with a resolution higher than HD (High Definition) resolution from a source device to a sink device such as a television apparatus, and relates to a source device for transmitting the video data, a sink device for receiving the video data, and a wireless communication system including the source device and the sink device.

### BACKGROUND ART

There has been established a Wireless HD (See the Non-Patent Document 1) of a standard for wirelessly transmitting an uncompressed baseband video signal and a digital audio signal among audio and visual equipments (referred to as AV (Audio and Visual) equipments hereinafter). The wireless HD is technical specifications for watching high-definition video data stored in a source device such as a digital video recorder, a set-top box and a personal computer, by using a sink device such as a high-definition television set without any cable connection between the source device and the sink device. In addition, since the technical specifications also include definitions of interactive control signals, it is possible to link the television set with the digital video recorder, and it is possible to provide a home theater or the like by using a plurality of AV equipments so that the AV equipments are controlled all together. A protocol for these controls is defined in the specifications. In addition, since it is possible to transmit high-quality content using the wireless HD, a DTCP (Digital Transmission Content Protection) is defined as a content protection system so that the provided content is not lawlessly reproduced or illegally copied.

For example, Patent Documents 1 to 3 and Non-Patent Document 1 describe wireless transmission methods compliant with WirelessHD according to prior art. In addition, Patent Documents 4 and 5 describe prior art methods of wirelessly transmitting AV data.

### CITATION LIST

### Patent Document

Patent Document 1: Japanese Patent Laid-open Publication No. JP 2008-252929 A;
Patent Document 2: Japanese Patent Laid-open Publication No. JP 2009-4877 A;
Patent Document 3: United States Patent Application Publication No. US 2007/0270121 A1;
Patent Document 4: United States Patent Application Publication No. US 2008/0320539 A1;
Patent Document 5: United States Patent Application Publication No. US 2009/0031365 A1;
Patent Document 6: Japanese Patent Laid-open Publication No. JP 2008-99189 A;
Patent Document 7: Japanese Patent Laid-open Publication No. JP 2005-328494 A; and
Patent Document 8: United States Patent Application Publication No. US 2005/0281296 A1.

### Non-Patent Documents

Non-Patent Document 1: WirelessHD Specification Version 1.0 Overview, Oct. 9, 2007.

### SUMMARY OF INVENTION

### Technical Problem

In recent years, next-generation video data has been widely used. The next-generation video data has a resolution higher than that of conventional high-definition resolution video data having, for example, 1920 effective horizontal pixels and 1080 effective vertical pixels. Such next-generation video data has 3840 or 4096 effective horizontal pixels and 2160 effective vertical pixels, and is called 4k2k video data. Patent Documents 6 to 8 disclose serial transmission methods for 4k2k video data. However, conventionally, in the WirelessHD, a method of wirelessly transmitting 4k2k video data has not been developed, and therefore, the 4k2k video data cannot be wirelessly transmitted.

It is an object of the present invention is to provide a video data transmission method capable of wirelessly transmitting 4k2k video data, a source device for transmitting the 4k2k video data, a sink device for receiving the 4k2k video data, and a wireless communication system including the source device and the sink device each capable of solving the above-described problems.

### Solution to Problem

A sink device according to a first invention is a sink device for a wireless communication system for wirelessly transmitting video data from a source device to the sink device. The sink device includes first control means for wirelessly transmitting a device capability response message to the source device, the device capability response message including (a) a video information message including at least one video format identification code for identifying a video format of video data, which the sink device can display, and (b) a coded video information message including compressing parameters for compressing video data. The at least one video format identification code includes at least one video format identification code for 4k2k video data having 3840 or 4096 effective horizontal pixels and 2160 effective vertical pixels.

In the above-described sink device, the source device wirelessly transmits a stream start notify message to the sink device, and thereafter, wirelessly transmits first video data to the sink device, the stream start notify message including a video format identification code for identifying a video format of the first video data to be transmitted, and data representing whether or not the first video data is compressed. The first control means wirelessly receives the stream start notify message from the source device, and identifies the video format identification code of the first video data and whether or not the first video data is compressed, based on wirelessly received stream start notify message. The first control means wirelessly receives the first video data. The first control means decompresses the first video data and decodes decompressed first video data based on an identified video format identification code when the first video data is compressed, and decodes the first video data based on the identified video format identification code when the first video data is not compressed.

In addition, in the above-described sink device, when the video format of the first video data is changed, the source device wirelessly transmits an output format notify message to the sink device, and thereafter, wirelessly transmits second video data having a changed video format to the sink device, the output format notify message including a video format identification code for identifying the changed video format, and data representing whether or not the second video data is compressed. The first control means wirelessly receives the output format notify message from the source device, and identifies the video format identification code of the second video data and whether or not the second video data is compressed, based on wirelessly received output format notify message. The first control means wirelessly receives the second video data. The first control means decompresses the second video data and decodes decompressed second video data based on an identified video format identification code when the second video data is compressed, and decodes the second video data based on the identified video format identification code when the second video data is not compressed.

A source device according to a second invention is a source device for a wireless communication system for wirelessly transmitting video data from the source device to a sink device. The source device comprises second control means for wirelessly transmitting a stream start notify message to the sink device, and thereafter, wirelessly transmitting first video data to the sink device, the stream start notify message including a video format identification code for identifying a video format of the first video data to be transmitted, and data representing whether or not the first video data is compressed. The video format identification code for identifying the video format of the first video data is selected from among at least one video format identification code for 4k2k video data having 3840 or 4096 effective horizontal pixels and 2160 effective vertical pixels.

In the above-described source device, the second control means wirelessly receives a device capability response message from the sink device, the device capability response message including (a) a video information message including at least one video format identification code for identifying a video format of video data, which the sink device can display, and (b) a coded video information message including compressing parameters for compressing video data. The second control means selects one video format identification code from among the video format identification code included in the device capability response message, generates the first video data based on a selected video format identification code, compresses a generated first video data using the compressing parameters, and wirelessly transmits compressed first video data to the sink device.

In addition, in the above-described source device, when the video format of the first video data is changed, the second control means wirelessly transmits an output format notify message to the sink device, and thereafter, wirelessly transmits second video data having a changed video format to the sink device, the output format notify message including a video format identification code for identifying the changed video format, and data representing whether or not the second video data is compressed.

A wireless communication system according to a third invention is a wireless communication system for wirelessly transmitting video data from a source device to a sink device. The wireless communication system includes the above-described sink device and the above-described source device.

A video data transmission method according to a fourth invention is a video data transmission method of wirelessly transmitting video data from a source device to a sink device. The method includes the following steps of:

by the sink device, wirelessly transmitting a device capability response message to the source device, the device capability response message including (a) a video information message including at least one video format identification code for identifying a video format of video data, which the sink device can display, and (b) a coded video information message including compressing parameters for compressing video data;

by the source device, wirelessly receiving the device capability response message, selecting one video format identification code from among the video format identification code included in the device capability response message, generating first video data based on a selected video format identification code, and compressing generated first video data using the compressing parameters;

by the source device, wirelessly transmitting a stream start notify message to the sink device, and thereafter, wirelessly transmitting compressed first video data to the sink device, the stream start notify message including the selected video format identification code, and data representing whether or not the first video data is compressed;

by the sink device, wirelessly receiving the stream start notify message, and identifying the video format identification code of the first video data and whether or not the first video data is compressed, based on wirelessly received stream start notify message; and

by the sink device, wirelessly receiving the first video data, and decompressing the first video data and decoding decompressed first video data based on an identified video format identification code when the first video data is compressed, and decoding the first video data based on the identified video format identification code when the first video data is not compressed. The at least one video format identification code includes at least one video format identification code for 4k2k video data having 3840 or 4096 effective horizontal pixels and 2160 effective vertical pixels.

The above-described video data transmission method further includes the following steps of:

when the video format of the first video data is changed, by the source device, wirelessly transmitting an output format notify message to the sink device, and thereafter, wirelessly transmitting second video data having a changed video format to the sink device, an output format notify message including a video format identification code for identifying the changed video format, and data representing whether or not the second video data is compressed;

by the sink device, wirelessly receiving the output format notify message, and identifying the video format identification code of the second video data and identifying whether or not the second video data is compressed, based on a wirelessly received output format notify message; and

by the sink device, wirelessly receiving the second video data; and

by the sink device, decompressing the second video data and decoding decompressed second video data based on an identified video format identification code when the second video data is compressed, and decoding the second video data based on the identified video format identification code when the second video data is not compressed.

### Advantageous Effects of Invention

According to a method of transmitting video data, a source device for transmitting the video data, a sink device for receiving the video data, and a wireless communication system including the source device and the sink device, according to the present inventions, the sink device wirelessly transmits a device capability response message to the source device. In this case, the device capability response message includes a video information message including at least one video format identification code for identifying a video format of video data that can be displayed on the sink device, and a coded video information message including compressing parameters for compressing video data. On the other hand, the source device wirelessly transmits a stream start notify message to the sink device, and thereafter, wirelessly transmits first video data to the sink device. In this case, the stream start notify message includes a video format identification code for identifying a video format of the first video data to be transmitted, and data representing whether or not the first video data is compressed. The video format identification code for identifying the video format of the first video data is selected from among at least one video format identification code for 4k2k video data having 3840 or 4096 effective horizontal pixels and 2160 effective vertical pixels. Therefore, 4k2k video data can be wirelessly transmitted.

### BRIEF DESCRIPTION OF DRAWINGS

FIG. 1 is a block diagram showing a configuration of a wireless communication system for transmitting video data using a video data transmission method according to a first preferred embodiment of the present invention;

FIG. 2 is a table showing a first part of VIC (Video format Identification Code) tables 115t and 127t of FIG. 1;

FIG. 3 is a table showing a second part of the VIC tables 115t and 127t of FIG. 1;

FIG. 4 is a table showing a third part of the VIC tables 115t and 127t of FIG. 1;

FIG. 5 is a sequence diagram showing operations of the wireless communication system of FIG. 1;

FIG. 6 is a diagram showing a format of a device capability request message 1 of FIG. 5;

FIG. 7 is a table showing types of device capability requested using a request type field 12 of FIG. 6;

FIG. 8 is a diagram showing a format of a device capability response message 2 of FIG. 5;

FIG. 9 is a diagram showing a relation among the device capability response message 2 of FIG. 5, a device information message 3, and an input format information message 5;

FIG. 10 is a diagram showing a format of the device information message 3 of FIG. 9;

FIG. 11 is a diagram showing a format of the input format information message 5 of FIG. 9;

FIG. 12 is a table showing a relation between values stored in a format type field 55 of FIG. 11, and format types;

FIG. 13 is a diagram showing a format of a video information message 200 of FIG. 9;

FIG. 14 is a diagram showing a format of a detailed timing information message 300 of FIG. 9;

FIG. 15 is a timing chart showing definitions of an effective horizontal interval Hactive, a horizontal blanking interval Hblank, a horizontal frequency Hfreq, an effective vertical interval Vactive, a vertical blanking interval Vblank, and a vertical frequency Vfeq;

FIG. 16 is a timing chart showing definitions of a horizontal synchronizing pulse front interval Hfront, a horizontal synchronizing pulse Hsync, a horizontal synchronizing pulse back interval Hback, a vertical synchronizing pulse front interval Vfront, a vertical synchronizing pulse Vsync, and a vertical synchronizing pulse back interval Vback;

FIG. 17 is a diagram showing a format of a coded video information message 400 of FIG. 9;

FIG. 18 is a diagram showing a format of a stream start notify message 8 of FIG. 5;

FIG. 19 is a table showing a relation between values stored in a format type field 91 of FIG. 18, and format types;

FIG. 20 is a diagram showing a format of a video format field 500 included in the stream start notify message 8 of FIG. 18, as a format field 90;

FIG. 21 is a diagram showing a format of a coded video format field 600 included in the stream start notify message 8 of FIG. 18, as the format field 90;

FIG. 22 is a diagram showing a format of an output format notify message 10 of FIG. 5;

FIG. 23 is a diagram showing a format of a coded video information message 400A according to a second preferred embodiment of the present invention;

FIG. 24 is a diagram showing a format of a coded video information message 400B according to a third preferred embodiment of the present invention;

FIG. 25 is a diagram showing a format of a coded video information message 400C according to a fourth preferred embodiment of the present invention;

FIG. 26 is a diagram showing a format of a coded video information message 400D according to a fifth preferred embodiment of the present invention, when a C field stores 1 and a compressing format number field 414 stores 0;

FIG. 27 is a diagram showing a format of the coded video information message 400D according to the fifth preferred embodiment of the present invention, when the C field stores 1 and the compressing format number field 414 stores N;

FIG. 28 is a diagram showing a format of a coded video information message 400E according to a sixth preferred embodiment of the present invention, when a CMM (Compression Method Multiple) field 418 stores 0b01;

FIG. 29 is a diagram showing a format of the coded video information message 400E according to the sixth preferred embodiment of the present invention, when the CMM field 418 stores 0b11;

FIG. 30 is a diagram showing a format of a coded video information message 400F according to a seventh preferred embodiment of the present invention;

FIG. 31 is a diagram showing a format of a coded video information message 400G according to an eighth preferred embodiment of the present invention;

FIG. 32 is a diagram showing a format of a coded video information message 400H according to a ninth preferred embodiment of the present invention;

FIG. 33 is a diagram showing a format of a coded video information message 400I according to a tenth preferred embodiment of the present invention;

FIG. 34 is a diagram showing a format of a coded video information message 400J according to an eleventh preferred embodiment of the present invention;

FIG. 35 is a diagram showing a format of a detailed timing information message 300A according to a twelfth preferred embodiment of the present invention;

FIG. 36 is a table showing a relation between VICs for 4k2k video formats, and timing values used in the twelfth and thirteenth preferred embodiments of the present invention;

FIG. 37 is a diagram showing a format of a detailed timing information message 300B according to the thirteenth preferred embodiment of the present invention;

FIG. 38 is a table showing a relation between extended field IDs stored in extended field ID fields 331-1 to 331-J of FIG. 37, and field names;

FIG. 39 is a table showing a relation between values stored in a format type field 55 in the input format information message 5 of FIG. 11, and format types in a fourteenth preferred embodiment of the present invention;

FIG. 40 is a diagram showing a format of an extended detailed timing information message 700 according to the fourteenth preferred embodiment of the present invention;

FIG. 41 is a table showing a relation between values stored in the format type field 55 in the input format information message 5 of FIG. 11, and format types in a fifteenth preferred embodiment of the present invention;

FIG. 42 is a diagram showing a format of an extended resolution detailed timing information message 800 according to the fifteenth preferred embodiment of the present invention;

FIG. 43 is a diagram showing a format of a coded video format field 600A according to a sixteenth preferred embodiment of the present invention;

FIG. 44 is a table showing a relation between values stored in a C_ID field 604 of FIG. 43, and compressing method;

FIG. 45 is a sequence diagram showing a device connection process according to a seventeenth preferred embodiment of the present invention, where the device connection process is initiated by a sink device 120 and a source device 110 does not request the sink device 120 for format information;

FIG. 46 is a sequence diagram showing a device connection process according to the seventeenth preferred embodiment of the present invention, where the device connection process is initiated by the sink device 120 and the source device 110 does not request the sink device 120 for the format information;

FIG. 47 is a table showing a first part of VIC tables 115t and 127t according to an eighteenth preferred embodiment of the present invention; and

FIG. 48 is a table showing a second part of the VIC tables 115t and 127t according to the eighteenth preferred embodiment of the present invention.

### DESCRIPTION OF EMBODIMENTS

Preferred embodiments according to the present invention will be described below with reference to the attached drawings. In the following preferred embodiments, components similar to each other are denoted by the same reference numerals.

### First Preferred Embodiment

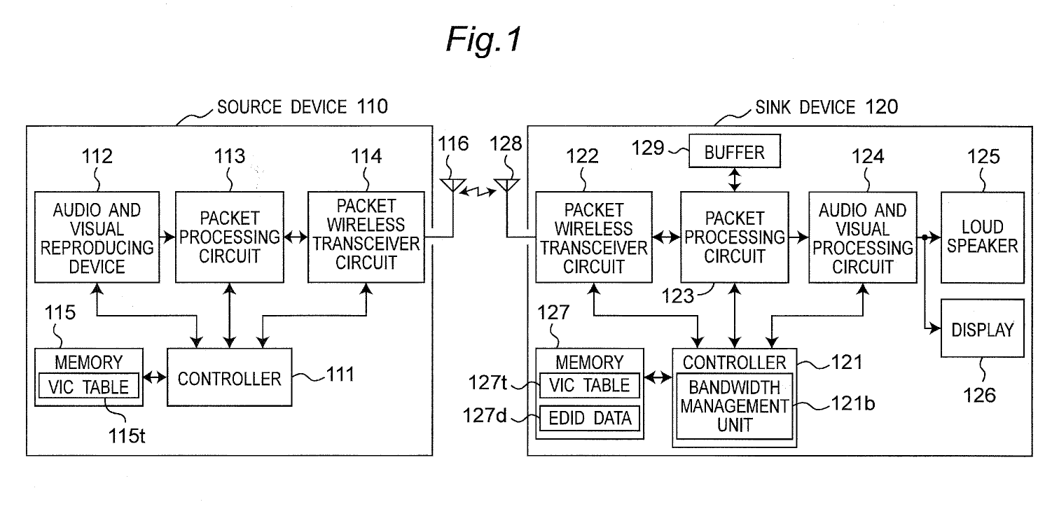

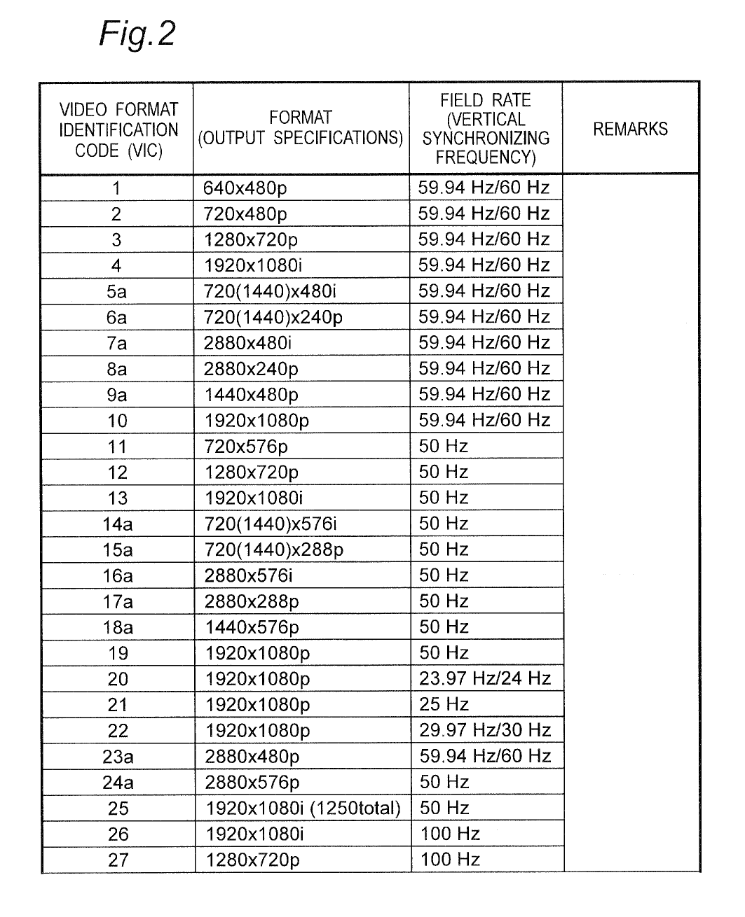

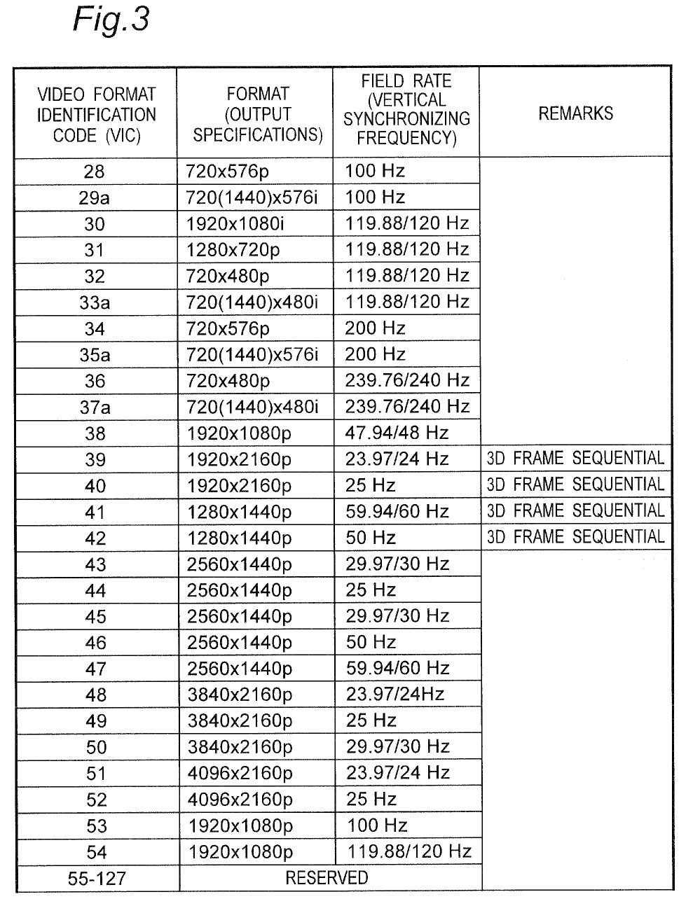

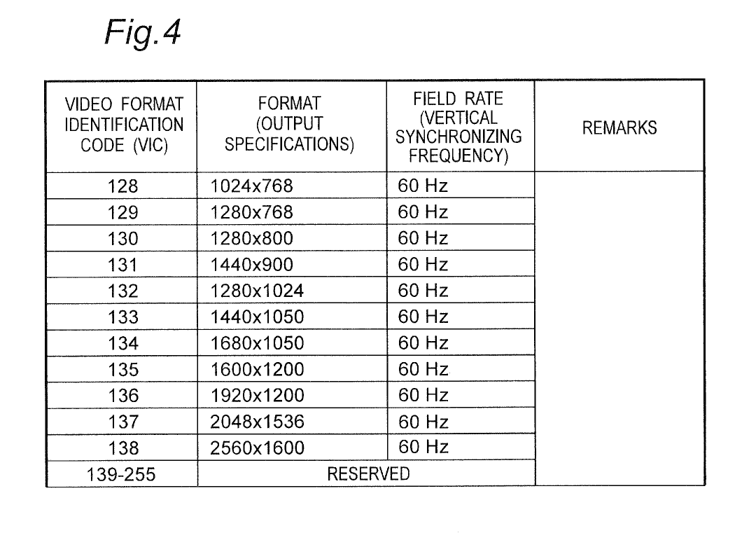

FIG. 1 is a block diagram showing a configuration of a wireless communication system for transmitting video data using a video data transmission method according to a first preferred embodiment of the present invention. In addition, FIGS. 2, 3, and 4 are tables showing VIC tables 115t and 127t of FIG. 1. It is to be noted that the configurations of a source device 110 and a sink device 120 of FIG. 1 are applied to the following first to seventeenth preferred embodiments.

Referring to FIG. 1, the wireless communication system according to the present preferred embodiment complies with WirelessHD. The source device 110, which functions as a source device for AV content data, is configured to include an audio and visual reproducing device 112, a packet processing circuit 113, a packet wireless transceiver circuit 114 having an antenna 116, a memory 115 for previously storing the VIC table 115t, and a controller 111 for controlling operations of these devices and circuits 112 to 115. The audio and visual reproducing device 112 is a DVD player, for example. The audio and visual reproducing device 112 reproduces video data and audio data from an external storage device or a recording medium such as an MD or a DVD, and outputs the video data and the audio data to the packet processing circuit 113. In this case, the video data is conventional high-definition resolution video data (referred to as HD video data hereinafter) or 4k2k video data having 3840 or 4096 effective horizontal pixels and 2160 effective vertical pixels. The packet processing circuit 113 converts inputted video data and audio data into a digital signal in a form of packet defined by the WirelessHD, and outputs the digital signal to the packet wireless transceiver circuit 114. In this case, when the inputted video data is the HD video data, the packet processing circuit 113 converts the HD video data into the digital signal without compressing the HD video data. On the other hand, when the inputted video data is the 4k2k video data, the packet processing circuit 113 compresses the 4k2k video data by a predetermined first compressing method, and converts compressed 4k2k video data into the digital signal. The packet wireless transceiver circuit 114 digitally modulates a carrier signal according to inputted digital signals, and wirelessly transmits a modulated wireless signal to a packet wireless transceiver circuit 122 of the sink device 120 via the antenna 116. On the other hand, a wireless signal wirelessly transmitted from the sink device 120 is received by the packet wireless transceiver circuit 114 via the antenna 116. The packet wireless transceiver circuit 114 demodulates a received wireless signal to a baseband signal, and thereafter, outputs the baseband signal to the packet processing circuit 113. The packet processing circuit 113 extracts only predetermined control commands from an inputted baseband signal by a predetermined packet separation process, and thereafter, outputs the control commands to the controller 111.

In addition, referring to FIG. 1, the sink device 120 is configured to include the packet wireless transceiver circuit 122 having an antenna 128, a packet processing circuit 123, an audio and visual processing circuit 124, a loudspeaker 125, a display 126 for displaying video data, a memory 127 for previously storing EDID (Extended Display Identification Data) data 127d and the VIC table 127t, a controller 121 for controlling operations of these circuits, etc., 122 to 124 and 127, and a buffer 129. In addition, the controller 121 is configured to include a bandwidth management unit 121b for managing bands used by a wireless network and signal transmission timing control. The packet wireless transceiver circuit 122 demodulates a wireless signal received via the antenna 128 to a baseband signal, and thereafter, outputs the baseband signal to the packet processing circuit 123. The packet processing circuit 123 decodes received packets by extracting only video data, audio data, and predetermined control commands from an inputted digital signal by a predetermined packet separation process, outputs the video data and the audio data to the audio and visual processing circuit 124 and outputs the control commands to the controller 121. In this case, when the extracted video data is compressed, the packet processing circuit 123 decompresses the video data using the buffer 129. The audio and visual processing circuit 124 executes predetermined signal processing and a D/A conversion process on inputted audio data, and thereafter, outputs processed audio data to the loudspeaker 125 so as to output sound. In addition, the audio and visual processing circuit 124 executes a predetermined signal processing and a D/A conversion processing on inputted video data, and outputs processed video data to the display 126 so as to display video.

Referring to FIGS. 2 to 4, each of the VIC tables 115t and 127t includes video format identifiers (VICs) for identifying video formats of video data. In this case, the video format represents a format of output specifications of video data, and includes information on a number of effective vertical pixels, a number of an effective horizontal pixels, a scanning method (progressive scanning (p) or interlaced scanning (i)), and a vertical synchronizing frequency (also referred to as a field rate hereinafter) of the video data. In the present preferred embodiment, VICs of 48 to 52 are assigned to the video formats (referred to as 4k2k video formats hereinafter) of 4k2k video data as follows.

(a) The VIC of 48 is assigned to a 4k2k video format having 3840 effective horizontal pixels, 2160 effective vertical pixels, a progressive scanning method, and a field rate of 23.97 Hz or 24 Hz.

(b) The VIC of 49 is assigned to a 4k2k video format having 3840 effective horizontal pixels, 2160 effective vertical pixels, the progressive scanning method, and a field rate of 25 Hz.

(c) The VIC of 50 is assigned to a 4k2k video format having 3840 effective horizontal pixels, 2160 effective vertical pixels, the progressive scanning method, and a field rate of 29.97 Hz or 30 Hz.

(d) The VIC of 51 is assigned to a 4k2k video format having 4096 effective horizontal pixels, 2160 effective vertical pixels, the progressive scanning method, and a field rate of 23.97 Hz or 24 Hz.

(e) The VIC of 52 is assigned to a 4k2k video format having 4096 effective horizontal pixels, 2160 effective vertical pixels, the progressive scanning method, and a field rate of 25 Hz.

It is to be noted that among the VICs shown in FIGS. 2 to 4, VIC modes appended with “a” are used if an output interface needs replicated pixels. It is the responsibility of the implementation to use these VIC at the transmitter (source device 110) and to create the video pixel replication at the receiver (sink device 120).

Referring to FIG. 1, the EDID data 127d includes data such as VICs for video data that can be displayed using the display 126 among the VICs included in the VIC table 127t, product information and a manufacturer name of the display 126, a video coding method (such as RGB, YCBCR 4:4:4 or YCBCR 4:2:2), and audio output specification (referred to as an audio format hereinafter) such as sound output sampling.

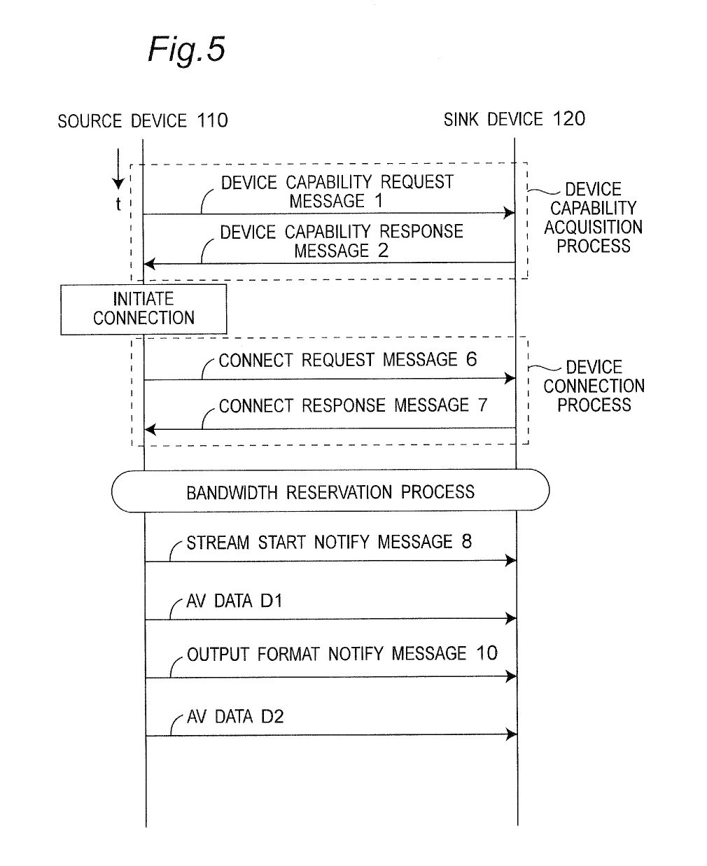

FIG. 5 is a sequence diagram showing operations of the wireless communication system of FIG. 1. First of all, a device capability acquisition process (an input format acquisition process) is executed between the source device 110 and the sink device 120 so that the source device 110 acquires information on video formats and audio formats supported by the sink device 120. In the device capability acquisition process, the source device 110 wirelessly transmits a device capability request (DEVICE_CAPABILITY_REQUEST) message (also referred to as a device information request message) 1 for requesting information on a device capability of the sink device 120, to the sink device 120. In response to this, the sink device 120 wirelessly transmits a device capability response (DEVICE_CAPABILITY_RESPONSE) message (also referred to as a device information response message) 2 including information on device capability of the sink device 120, to the source device 110.

Next, referring to FIG. 5, a device connection process is performed between the source device 110 and the sink device 120. In the present preferred embodiment, the source device 110 initiates the device connection process, and a port reservation process and a bandwidth reservation process. First of all, in the device connection process, the source device 110 wirelessly transmits a connect request (CONNECT_REQUEST) message 6 compliant with the WirelessHD to the sink device 120 to confirm whether to transmit AV data to the sink device 120 or not. In this case, an S bit in the connect request message 6 is set to zero, and a port field in the connect request message 6 contains data representing a source port. When the sink device 120 receives the connect request message 6, the sink device 120 wirelessly transmits a connect response (CONNECT_RESPONSE) message 7, which is compliant with the WirelessHD and includes a result of the connection request from the source device 110, to the source device 110. In this case, if the sink device 110 accepts the connection request from the source device 110, the sink device 110 stores data representing “Success” in a result code field in the connect response message 7, and stores data on a sink port reserved for AV data transmission in a sink port field in the connect response message 7. If an RF bit in the connect request message 6 is set to 1, the sink device 120 stores information on formats supported by the sink device 120 in predetermined fields (a total data length field, a format type field, a data length field, and a format data field) in the connect response message 7. If the RF bit in the connect request message 6 is set to zero, the sink device 120 stores zero in the total data length field of the connect response message 7. If the sink device 120 rejects the connection request from the source device 110, the sink device 120 stores data representing “Failure” with an appropriate reason in the result code field in the connect response message 7.

Referring to FIG. 5, after wirelessly receiving the connect response message 7 which indicates “Success”, the source device 110 performs a bandwidth (resource) reservation process compliant with the WirelessHD for securing a transmission bandwidth for transmitting AV content data including the video data and the audio data from the source device 110 to the sink device 120. In the bandwidth reservation process, in order to request a bandwidth for transmitting the AV data and to reserve the bandwidth, the source device 110 wirelessly transmits a bandwidth request command to the sink device 120. In response to this, the bandwidth management unit 121b of the sink device 120 allocates a reservation time period required for transmitting the AV content data from the source device 110 to the sink device 120, and wirelessly transmits an time period designation command including information on the allocated reservation time period to the source device 110.

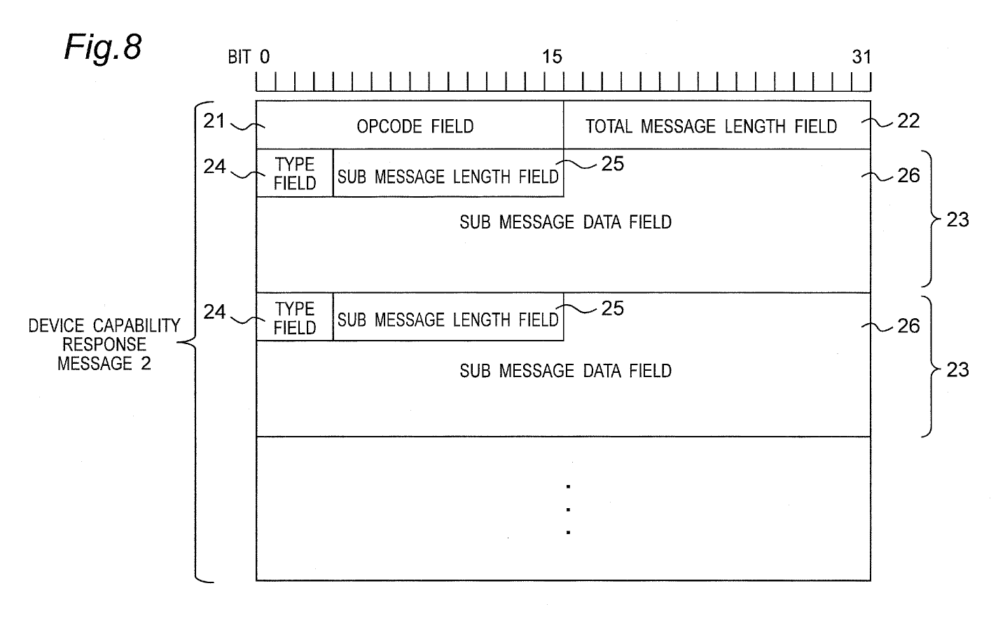

Further, referring to FIG. 5, after the source device 110 successfully completes the bandwidth reservation process, the source device 110 wirelessly transmits a stream start notify message 8 to the sink device 120. In this case, data representing “Success” is stored in a result code field 82 (See FIG. 8) in the stream start notify message 8. It is to be noted that if the source device 110 fails the bandwidth reservation process, the source device 110 wirelessly transmits the stream start notify message 8 including the result code field 82 storing data representing “Failure”. As described later in detail, the stream start notify message 8 includes information on a video format and information on an audio format of AV data transmitted to the sink device 120. Once an HRP (High Rate Physical Layer) stream is allocated, the source device 110 wirelessly transmits HRP packets with only a PHY (Physical layer) header and a MAC (Medium Access Control) header until the source device 110 receives an ACK (Acknowledgement) signal from the sink device 120, which indicates that the sink device 120 ready to receive HRP packets with data for this stream. After the source device 110 receives the ACK signal, the source device 110 inserts AV data into the HRP packets and wirelessly transmits the HRP packets to the sink device 120.

In addition, referring to FIG. 5, when at least one of the video format and the audio format of the AV data is changed, the source device 110 wirelessly transmits an output format notify message (OUTPUT_FORMAT_NOTIFY) message 10 including information on the changed video format or audio format before wirelessly transmitting AV data having the changed video format and audio format to the sink device 120.

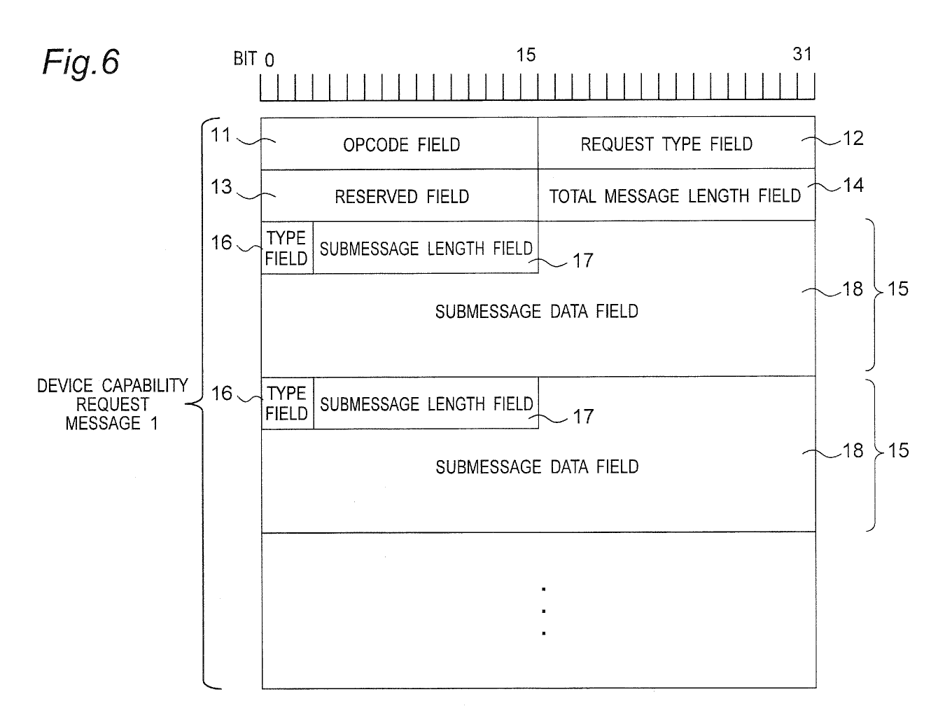

FIG. 6 is a diagram showing a format of the device capability request message 1 of FIG. 5. Referring to FIG. 6, the device capability request message 1 includes the following fields.

(1) An opcode field 11 storing data representing a type of the device capability request message 1. Referring to FIG. 6, the opcode field 11 stores data representing that this device capability request message 1 is a device capability request message.

(2) A request type field 12 storing bitmap data representing a type of a device capability requested to the sink device 120.

(3) A reserved field 13 reserved for future use.

(4) A total message length field 14 storing data representing a data length of fields excluding the opcode field 11, the request type field 12, the reserved field 13, and the total message length field 14 from the device capability request message 1.

(5) At least one sub message 15 each including a type field 16, a sub message length field 17, and a sub message data field 18.

It is to be noted that, in the sub message 15, the type field 16 stores data representing a type of data stored in the sub message data field 18, the sub message length field 17 stores data representing a data length of the data stored in the sub message data field 18, and the sub message data field 18 stores the data having the type stored in the type field 16. Further, a header (not shown) including data on an ID of a destination device to which the device capability request message 1 is transmitted and an ID of the source device 110 that is a sender of the device capability request message 1 are added to the device capability request message 1.

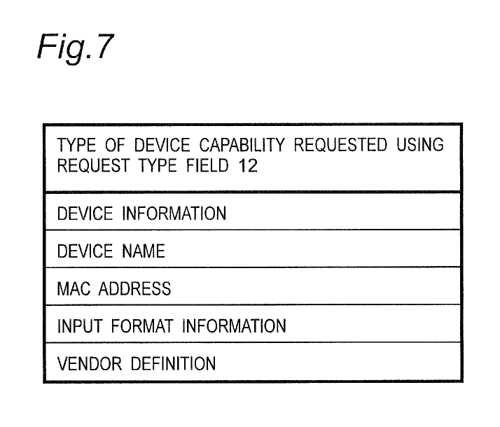

FIG. 7 is a table showing types of the device capability requested using the request type field 12 of FIG. 6. As shown in FIG. 7, the types of the device capability requested using the request type field 12 includes device information, a device name, a MAC address, input format (supported format) information, and a vendor definition. For example, when requesting the sink device 120 to transmit the input format information, the source device 110 sets 1 to a bit which corresponds to the input format information among bits of the bitmap data stored in the request type field 12.

FIG. 8 is a diagram showing a format of the device capability response message 2 of FIG. 5. Referring to FIG. 8, the device capability response message 2 includes the following fields.

(1) An opcode field 21 storing data representing a type of the device capability response message 2. Referring to FIG. 8, the opcode field 21 stores data representing that this device capability response message 2 is a device capability response message.

(2) A total message length field 22 storing data representing a data length of fields excluding the opcode field 21 and the total message length field 2 from the device capability response message 2.

(3) At least one sub message 23 each including a type field 24, a sub message length field 25, and a sub message data field 26.

It is to be noted that, in the sub message 23, the type field 24 stores data representing a type of data stored in the sub message data field 26, the sub message length field 25 stores data representing a data length of the data stored in the sub message data field 26, and the sub message data field 26 stores the data having the type stored in the type field 24. The sub message 23 including the type field 24 storing the data corresponding to the device information is referred to as a device information message 3, and the sub message 23 including the type field 24 storing data corresponding to the input format information is referred to as an input format information message 5 hereinafter. It is to be noted that a header (not shown) including an ID of a destination device to which the device capability response message 2 is transmitted and an ID of the sink device 120 that is a sender of the device capability response message 2.

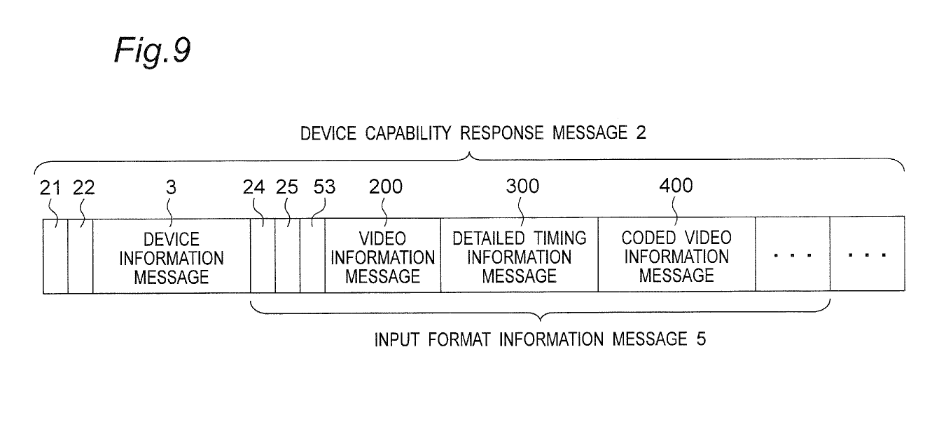

FIG. 9 is a diagram showing a relation among the device capability response message 2 of FIG. 5, the device information message 3, and the input format information message 5. When 1 is set to the bit corresponding to the device information of the bitmap data stored in the request type field 12 of the received device capability request message 1, the sink device 120 stores data corresponding to the device information in the type field 24 of one sub message 23 of the device capability response message 2, and wirelessly transmits the sub message 23 to the source device 110 as the device information message 3. In addition, when 1 is set to the bit corresponding to the input format information of the bitmap data stored in the request type field 12 of the received device capability request message 1, the sink device 120 stores data corresponding to the input format information in the type field 24 of one sub message 23 of the device capability response message 2, and wirelessly transmits the sub message 23 to the source device 110 as the input format information message 5.

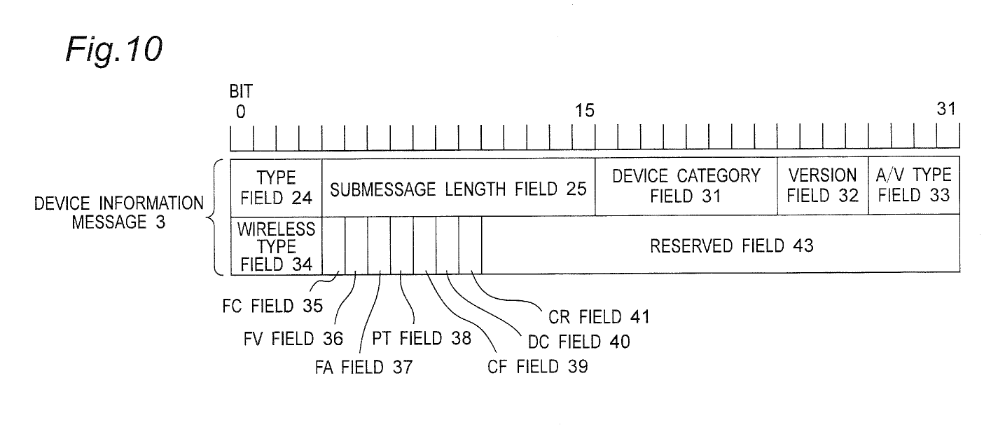

FIG. 10 is a diagram showing a format of the device information message 3 of FIG. 9. Referring to FIG. 10, the device information message 3 includes the following fields.

(1) The type field 24 storing the data corresponding to the device information.

(2) The sub message length field 25 storing the data representing the data length of fields excluding the type field 24 and the sub message length field 25 from the device information message 3.

(3) A device category field 31 storing data representing a device category such as a television broadcasting receiver, a DVD player, or a set-top box.

(4) A version field 32 storing data representing a version of the specification. For example, the version field 32 stores 1 if the version of the specification is 1.0 or 1.0a, and stores 2 if the version of the specification is 1.1.

(5) An A/V type field 33 storing bitmap data representing an A/V type. Bit 0 (LSB: Least Significant Bit) of the bitmap data representing the A/V type is allocated to a function of a video source device, bit 1 is allocated to a function of a video sink device, bit 2 is allocated to a function of an audio source device, and bit 3 is allocated to a function of an audio sink device. If a value of a bit in the bitmap data is set to 1, it represents that a device supports a function corresponding to the bit. On the other hand, if the value of the bit is set to 0, it represents that the device does not support the function corresponding to the bit.

(6) A wireless type field 34 storing data representing a wireless type such as a wireless type which enables fast transmission and reception.

(7) An FC (Fast Connect) field 35 storing data representing whether or not the source device 110 supports a fast connect sequence function. The FC field 35 stores 1 when the source device 110 supports the fast connect sequence function, and stores 0 when the source device 110 does not support the fast connect sequence function.

(8) An FV (Fast Video) field 36 storing data representing whether or not the source device 110 supports a predetermined fast video adaptation function. The FV field 36 stores 1 when the source device 110 supports the predetermined fast video adaptation function, and stores 0 when the source device 110 does not support the predetermined fast video adaptation function.

(9) An FA (Fast Audio) field 37 storing data representing whether or not the source device 110 supports a predetermined fast audio adaptation function. The FA field 37 stores 1 when the source device 110 supports the predetermined fast audio adaptation function, and stores 0 when the source device 110 does not support the predetermined fast audio adaptation function.

(10) A PT (Pass Through) field 38 storing data representing whether or not a device supports an HDMI (High-Definition Multimedia Interface) pass-through mode as specified in the WirelessHD. The PT field 38 stores 1 when the device supports an HDMI pass-through mode, and stores 0 when the device does not support the HDMI pass-through mode.

(11) A CF (Content Flag) field 39 storing data representing whether or not a device is a sink device and supports a predetermined content type notify function. The CF field 39 stores 1 when the device supports the content type notify function, and stores 0 when the device does not support the content type notify function.

(12) A DC (Device Control) field 40 storing data representing whether or not a device supports a device control function (DEVCTRL). The DC field 40 stores 1 when the device supports the device control function, and stores 0 when the device does not support the device control function.

(13) A CR (Chroma) field 41 storing data representing whether or not a device supports predetermined chroma partitioning. The CR field 41 stores 1 when the device supports the chroma partitioning, and stores 0 when the device does not support the chroma partitioning.

(14) A reserved field 43 reserved for future use.

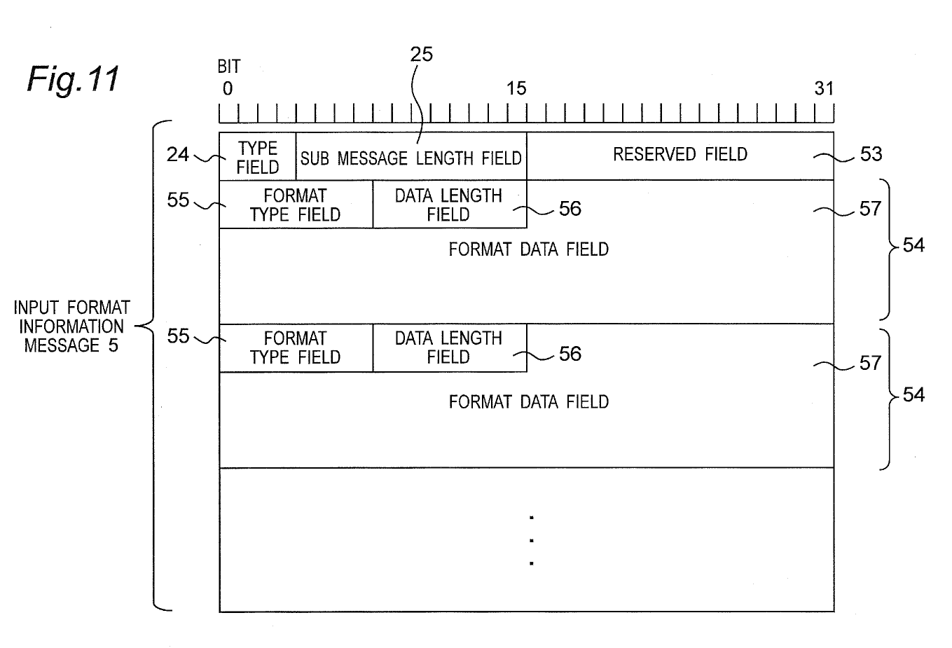

FIG. 11 is a diagram showing a format of the input format information message 5 of FIG. 9. Referring to FIG. 11, the input format information message 5 includes the following fields.

(1) The type field 24 storing the data corresponding to the input format information.

(2) The sub message length field 25 storing the data representing a data length of fields excluding the type field 24 and the sub message length field 25 from the input format information message 5.

(3) A reserved field 53 reserved for future use.

(4) At least one format data message 54 each including a format type field 55, a data length field 56, and a format data field 57.

In this case, in each format data message 54, the format type field 55 stores data representing a type of data stored in the format data field 57, the data length field 56 stores data representing a data length of the data stored in the format data field 57, and the format data field 57 stores the data having the format type stored in the format type field 55.

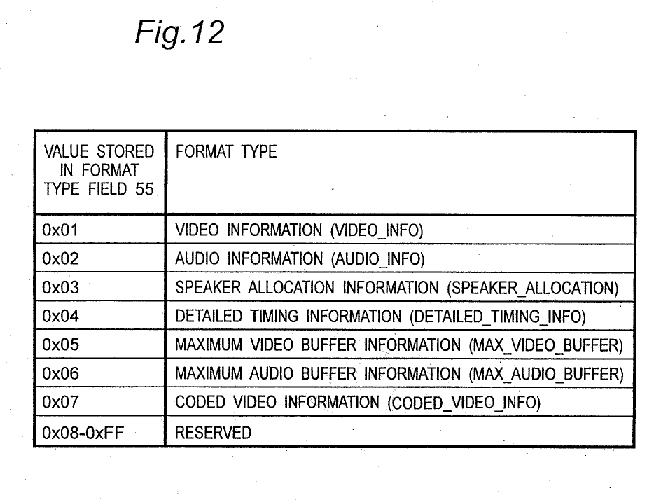

FIG. 12 is a table showing a relation between values stored in the format type field 55 of FIG. 11, and format types. As shown in FIG. 12, the format types corresponding to the values stored in the format type field 55 include video information (VIDEO_INFO), audio information (AUDIO_INFO), a loudspeaker allocation information (SPEAKER_ALLOCATION), detailed timing information (DETAILED_TIMING_INFO), maximum video buffer information (MAXIMUM_VIDEO_BUFFER), maximum audio buffer information (MAXIMUM_AUDIO_BUFFER), and coded (compressed) video information (CODED_VIDEO_INFO). The format data message 54 including the format type field 55 storing the value (0x01) corresponding to the video information is referred to as a video information message 200 hereinafter. The format data message 54 including the format type field 55 storing the value (0x04) corresponding to the detailed timing information is referred to as a detailed timing information message 300 hereinafter. The format data message 54 including the format type field 55 storing the value (0x07) corresponding to the coded video information is referred to as a coded video information message 400 hereinafter (See FIG. 9). In the present specification, a numeric value starting from 0x represents a hexadecimal number, and a numeric value starting from 0b represents a binary number.

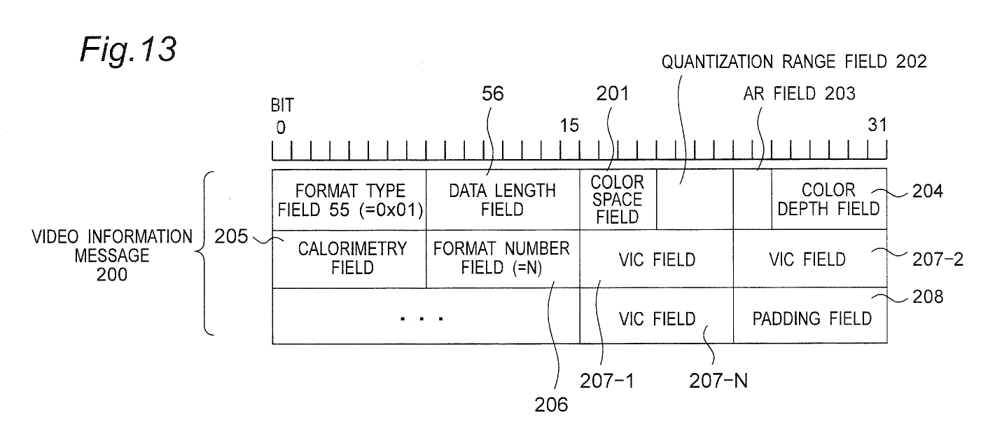

FIG. 13 is a diagram showing a format of the video information message 200 of FIG. 9. Referring to FIG. 13, the video information message 200 includes the following fields.

(1) The format type field 55 storing the value (0x01) corresponding to the video information.

(2) The data length field 56 storing the data representing the data length of the fields excluding the format type field 55 and the data length field 56 from the video information message 200.

(3) A color space field 201 storing bitmap data representing a supported color space. Bit 0 of the bitmap data stored in the color space field 201 is allocated to RGB, bit 1 is allocated to YCbCr422, bit 2 is allocated to YCbCr444, and bit 3 is a reserved bit. When a value of a bit among the bits of the bitmap data is set to 1, this indicates that the color space corresponding to the bit is supported. On the other hand, when a value of a bit among the bits of the bitmap data is set to 0, this indicates that the color space corresponding to the bit is not supported.

(4) A quantization range (QC) field 202 storing bitmap data representing whether the device supports full range or limited range RGB quantization, and whether the device supports full range or limited range YCrCb quantization. Values of the quantization range are defined in IEC61966-2-1. When bit 0 of the bitmap data stored in the quantization range field 202 is 1, this indicates that the device supports the RGB quantization of the full range. When the bit 0 of the bitmap data stored in the quantization range field 202 is 0, this indicates that the device supports the RGB quantization of the limited range. In addition, when bit 1 of the bitmap data stored in the quantization range field 202 is 1, this indicates that the device supports the YCrCb quantization of the full range. When the bit 1 of the bitmap data stored in the quantization range field 202 is 0, this indicates that the device supports the YCrCb quantization of the limited range. Bits 2 and 3 of the bitmap data stored in the quantization range field 202 are reserved bits. The source device 110 does not transmit full-range data to the sink device that does not support the same data. Adobe601 and sYCC601 are always full range.

(5) An AR (Aspect Ratio) field 203 storing bitmap data representing supported aspect ratio. Bit 0 of the bitmap data stored in the AR field 203 is allocated to an aspect ratio of 4:3, and bit 1 is allocated to an aspect ratio of 16:9.

When a value of a bit of the bitmap data is set to 1, this indicates that the aspect ratio corresponding to the bit is supported. When a value of a bit of the bitmap data is set to 0, this indicates that the aspect ratio corresponding to the bit is not supported.

(6) A color depth field 204 storing bitmap data representing supported color depth. Bit 0 of the bitmap data stored in the color depth field 204 is allocated to a color depth of 24 bits, bit 1 is allocated to a color depth of 30 bits, bit 2 is allocated to a color depth of 36 bits, bit 3 is allocated to a color depth of 48 bits, and bits 4 and 5 are reserved bits. When a value of a bit of the bitmap data is set to 1, this indicates that the color depth corresponding to the bit is supported. When a value of a bit of the bitmap data is set to 0, this indicates that the color depth corresponding to the bit is not supported.

(7) A colorimetry field 205 storing data representing supported colorimetry. Bit 0 of bitmap data stored in the colorimetry field 205 is allocated to ITU601/SMPTE 170M, bit 1 is allocated to ITU709, bit 2 is allocated to xvYCC601 for supporting IEC61966-2-4 with standard definition primaries, bit 3 is allocated to xvYCC709 for supporting IEC61966-2-4 with high definition primaries, bit 4 is allocated to sYCC601 for supporting IEC61966-2-1-am1 with still picture primaries, bit 5 is allocated to Adobe YCC601 for supporting IEC61966-2-5 (CVD) with still picture primaries, bit 6 is allocated to Adobe RGB, and bit 7 is a reserved bit. However, when the sink device does not support the RGB color space, the bit 6 of the bitmap data stored in the colorimetry field 205 is set to 0, and when the sink device does not support the YCbCr color space, the bit 2 is set to 0.

(8) A format number field 206 storing a total number N (where N is an integer equal to or larger than 1) of video formats which the sink device 120 supports.

(9) N VIC fields 207-1 to 207-N storing VICs of the respective video formats which the sink device 120 supports.

(10) A padding field 208 provided to set the message length of the video information message 200 to an integer multiple of a predetermined data length unit (32 bits in the present preferred embodiment).

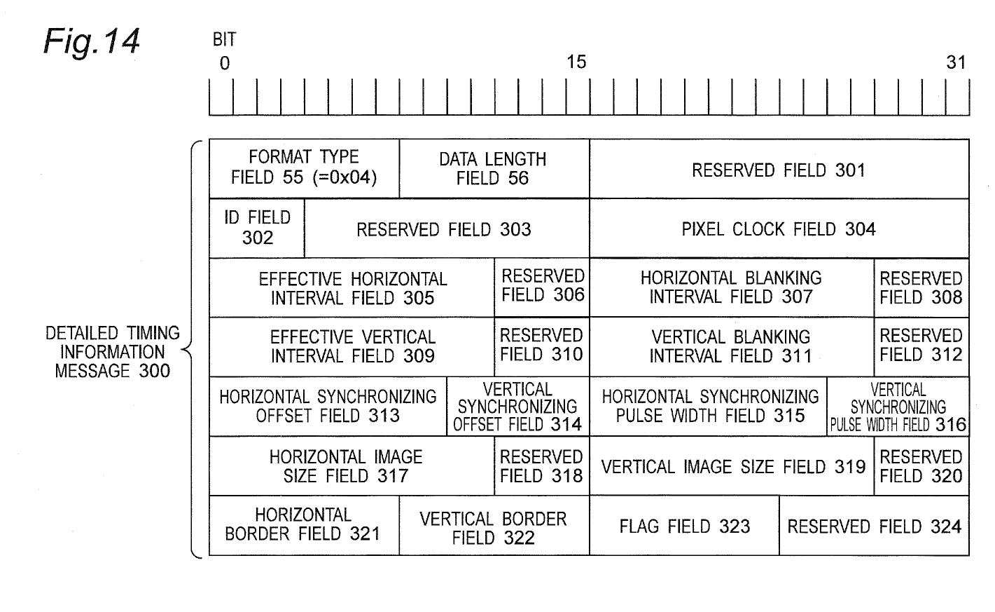

FIG. 14 is a diagram showing a format of the detailed timing information message 300 of FIG. 9. Referring to FIG. 14, the detailed timing information message 300 includes the following fields:

(1) The format type field 55 storing the value (0x04) corresponding to the detailed timing information.

(2) The data length field 56 storing data representing the data length of the fields excluding the format type field 55 and the data length field 56 from the detailed timing information message 300.

(3) An ID field 302 storing an ID number of the detailed timing information (Detailed Timing Info).

(4) A pixel clock field 304 storing a pixel clock frequency.

(5) An effective horizontal interval field 305 storing a number of effective pixels in an effective horizontal interval Hactive.

(6) A horizontal blanking interval field 307 storing a number of pixels in a horizontal blanking interval (blank interval) Hblank.

(7) An effective vertical interval field 309 storing a number of effective pixels in an effective vertical interval Vactive.

(8) A vertical blanking interval field 311 storing a number of pixels in a vertical blanking interval Vblank.

(9) A horizontal synchronizing offset field 313 storing a value representing, by a number of pixels, a length of a horizontal synchronizing pulse front interval (horizontal synchronizing offset interval) Hfront which is an offset interval starting from the beginning of the horizontal blanking interval Hblank of a horizontal synchronizing pulse Hsync.

(10) A vertical synchronizing offset field 314 storing a value representing, by a number of pixels, a length of a vertical synchronizing pulse front interval (vertical synchronizing offset interval) Vfront which is an offset interval starting from the beginning of the vertical blanking interval Vblank of a vertical synchronizing pulse Vsync.

(11) A horizontal synchronizing pulse width field 315 storing a value representing a pulse width of the horizontal synchronizing pulse Hsync by a number of pixels.

(12) A vertical synchronizing pulse width field 316 storing a value representing a pulse width of the vertical synchronizing pulse Vsync by a number of pixels.

(13) A horizontal image size field 317 storing a value representing a size of an image in a horizontal direction in millimeters.

(14) A vertical image size field 319 storing a value representing a size in of the image a vertical direction in millimeters.

(15) A horizontal border field 321 storing data representing a border in the horizontal direction.

(16) A vertical border field 322 storing data representing a border in the vertical direction.

(17) A flag field 323 storing information on stereo video.

(18) Reserved fields 301, 303, 306, 308, 310, 312, 318, 320, and 324 reserved for future use.

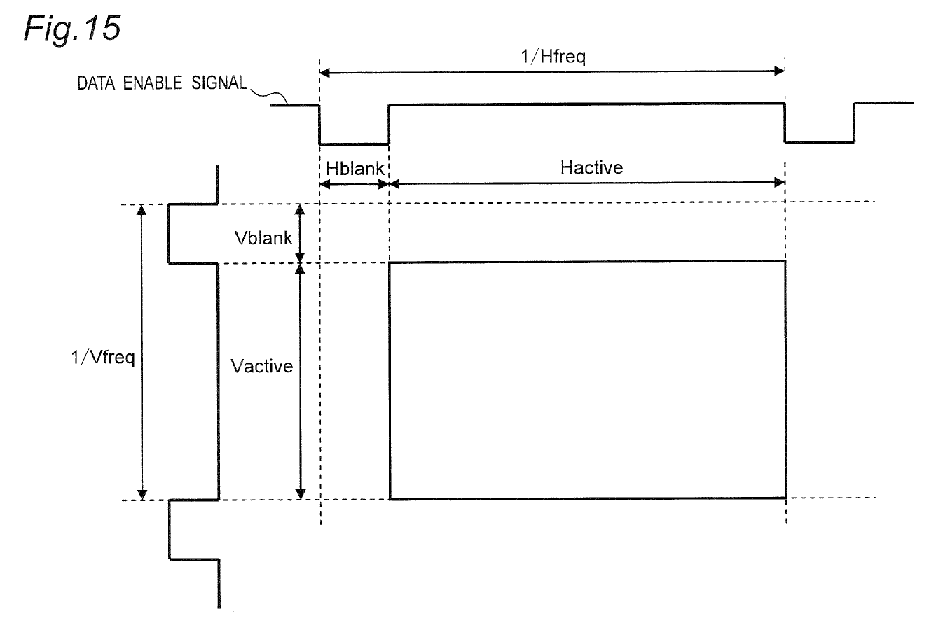

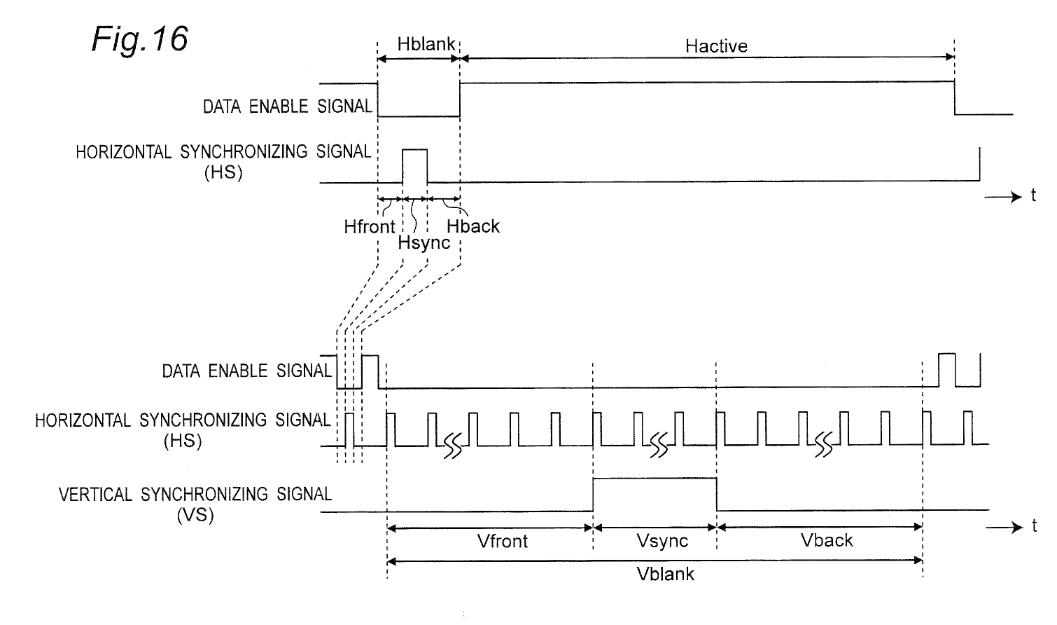

FIG. 15 is a timing chart showing definitions of the effective horizontal interval Hactive, the horizontal blanking interval Hblank, a horizontal frequency Hfreq, the effective vertical interval Vactive, the vertical blanking interval Vblank, and a vertical frequency Vfreq. FIG. 16 is a timing chart showing definitions of the horizontal synchronizing pulse front interval Hfront, the horizontal synchronizing pulse Hsync, the horizontal synchronizing pulse back interval Hback, the vertical synchronizing pulse front interval Vfront, the vertical synchronizing pulse Vsync, and the vertical synchronizing pulse back interval Vback. Referring to FIG. 16, a data enable signal represents start and end timings of effective pixels, and a horizontal synchronizing signal HS transmits the horizontal synchronizing pulse Hsync, and a vertical synchronizing signal VS transmits the vertical synchronizing pulse Vsync. In addition, the horizontal synchronizing pulse front interval Hfront is an interval before a level of the horizontal synchronizing signal HS in the horizontal blanking interval Hblank becomes a high level, the horizontal synchronizing pulse Hsync is an interval for which the horizontal synchronizing signal HS has the high level, and the horizontal synchronizing pulse back interval Hback is an interval for which the horizontal synchronizing signal HS after the horizontal synchronizing pulse Hsync in the horizontal blanking interval Hblank has a low level. Further, the vertical synchronizing pulse front interval Vfront is an interval before a level of the vertical synchronizing signal VS becomes the high level in the vertical blanking interval Vblank, the vertical synchronizing pulse Vsync is an interval for which the vertical synchronizing signal VS has the high level, and the vertical synchronizing pulse back interval Vback is an interval for which the vertical synchronizing signal VS after the vertical synchronizing pulse Vsync in the vertical blanking interval Vblank has the low level.

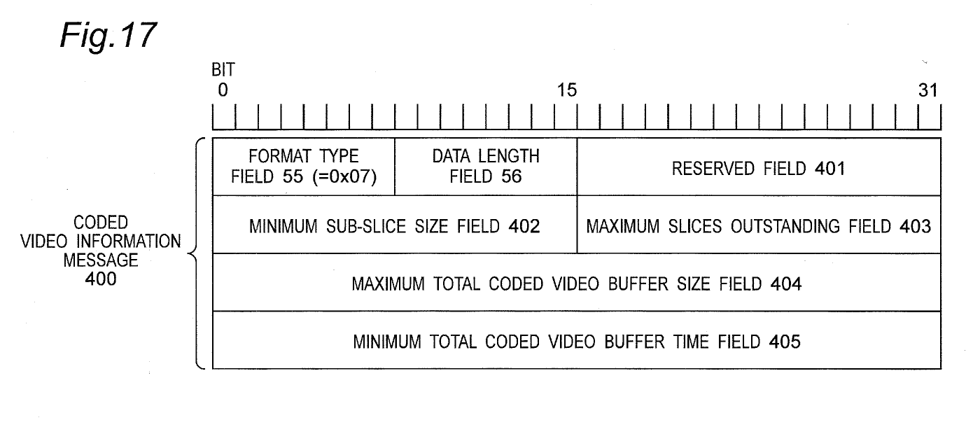

FIG. 17 is a diagram showing a format of the coded video information message 400 of FIG. 9. Referring to FIG. 17, the coded video information message 400 includes the following fields.

(1) The format type field 55 storing the value (0x07) corresponding to the coded video information.

(2) The data length field 56 storing the data representing the data length of the fields excluding the format type field 55 and the data length field 56 from the coded video information message 400.

(3) A reserved field 401 reserved for future use.

(4) A minimum sub-slice size field 402 storing data representing a minimum sub-slice size, in octets, that the sink device 120 is able to handle.

(5) A maximum slices outstanding field 403 storing data representing a maximum number of slices that the sink device 120 is able to buffer.

(6) A maximum total coded video buffer size field 404 storing data representing a maximum size, in octets, of the sink device's 120 buffer 129 allocated for coded (compressed) video data.

(7) A maximum total coded video buffer time field 405 storing data representing a maximum time that the sink device 120 is able to buffer for coded (compressed) video data.

Referring to FIG. 17, parameters stored in the respective fields 402 to 405 are compressing parameters used when the source device 110 compresses video data by a predetermined first compressing method. It is to be noted that when the sink device 120 can decompress compressed video data, the sink device 120 transmits the coded video information message 400 to the source device 110. On the other hand, when the sink device 120 cannot decompress the compressed video data, the sink device 120 does not transmit the coded video information message 400 to the source device 110.

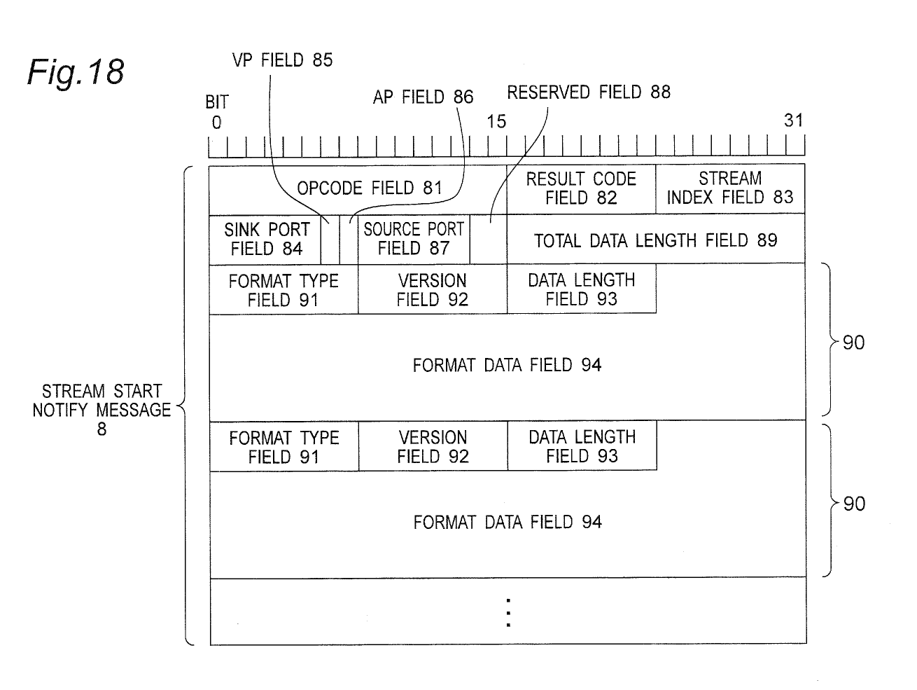

FIG. 18 is a diagram showing a format of the stream start notify message 8 of FIG. 5. The stream start notify message 8 is used by the source device 110B to notify the sink device 120B of a result of the bandwidth reservation process of FIG. 5, and an output format of the AV data (namely, the video format of the video data and the audio format of the audio data included in the AV data). Referring to FIG. 18, the stream start notify message 8 includes the following fields.

(1) An opcode field 81 storing an operation code of the stream start notify message 8.

(2) A result code field 82 storing data representing whether or not the bandwidth reservation process of FIG. 5 succeeds (whether or not transmission of a stream normally starts).

(3) A stream index field 83 storing a stream index obtained (or allocated) from a MAC layer in the bandwidth reservation process of FIG. 5.

(4) A sink port field 84 storing a sink port number reserved for transmission of the AV data.

(5) A VP field 85 storing 1 when a sink port and a source port are used for the video data, and storing 0 when the sink port and the source port are not used for the video data.

(6) An AP field 86 storing 1 when the sink port and the source port are used for the audio data, and storing 0 when the sink port and the source port are not used for the audio data.

(7) A source port field 87 storing a source port number reserved for transmission of the AV data.

(8) A reserved field 88 reserved for future use.

(9) A total data length field 89 storing data representing a data length of fields excluding the opcode field 81 and the total data length field 89 from the stream start notify message 8.

(10) At least one format field 90 each including a format type field 91, a version field 92, a data length field 93, and a format field 94.

In this case, in each format field 90, the format type field 91 stores data representing a type of data stored in the format data field 94, the version field 92 stores a version number of standards of the format data field 94, the data length field 93 stores data representing a data length of the data stored in the format data field 94, and the format data field 94 stores the data having the format type stored in the format type field 91.

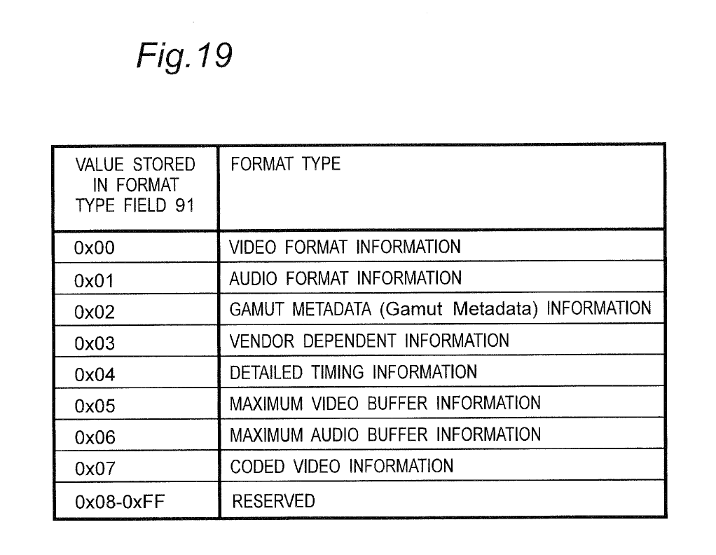

FIG. 19 is a table showing a relation between values stored in the format type field 91 of FIG. 18, and format types. As shown in FIG. 19, the format types corresponding to the respective values stored in the format type field 91 include video format information, audio format information, gamut metadata information, vendor dependent information, detailed timing information, maximum video buffer information, maximum audio buffer information, and coded video information (compressed video information). The format field 90 including the format type field 91 storing a value (0x00) corresponding to the video format information will be referred to as a video format field 500, and the format field 90 including the format type field 91 storing a value (0x07) corresponding to the coded video information will be referred to as a coded video format field 600 hereinafter.

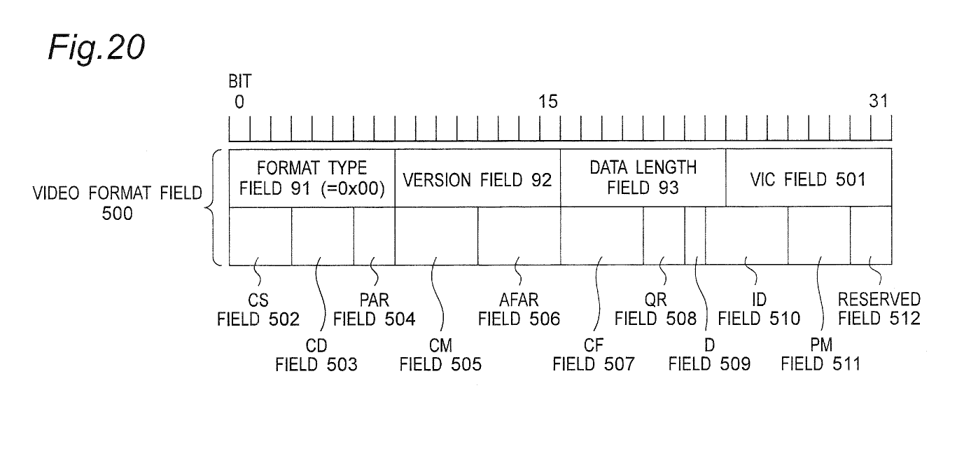

FIG. 20 is a diagram showing a format of the video format field 500 included in the stream start notify message 8 of FIG. 18 as a format field 90. Referring to FIG. 20, the video format field 500 includes the following fields.

(1) The format type field 91 storing a value (0x00) corresponding to the video format information.

(2) The version field 92 storing the version number of the specification of the following fields 501 to 512.

(3) The data length field 93 storing the data representing the data length of the fields excluding the format type field 91, the version field 92, and the data length field 93 from the video format field 500.

(4) A VIC field 501 storing the VIC representing the video format of the video data to be transmitted.

(5) A CS (Color Space) field 502 storing data representing the type of color format of the video data to be transmitted. The CS field 502 stores 0 when the type of color format is RGB, stores 1 when the type of color format is YCbCr422, and stores 2 when the type of color format is YCbCr444. Values from 3 to 7 are reserved values.

(6) A CD (Color Depth) field 503 storing a number of bits of the color depth of the video data to be transmitted. The CD field 503 stores 0 when the color depth is 24 bits, stores 1 when the color depth is 30 bits, stores 2 when the color depth is 36 bits, and stores 3 when the color depth is 48 bits. Values from 4 to 7 are reserved values.

(7) A PAR (Picture Aspect Ratio) field 504 storing data representing the aspect ratio of the video to be transmitted. The PAR field 504 stores 9 when the picture aspect ratio is 4:3, stores 10 when the picture aspect ratio is 16:9, and stores 11 when the picture aspect ratio is 14:9. Values from 1 to 8 and values from 12 to 15 are reserved values.

(8) A CM (Colorimetry) field 505 storing colorimetry information (ITUBT.601, BT.709, etc.) of the video data to be transmitted. The CM field 505 stores 0 when there is no colorimetry data, stores 1 when the colorimetry is ITU 601/SMPTE 170M, stores 2 when the colorimetry is ITU 709, stores 3 when the colorimetry is xvYCC 601, stores 4 when the colorimetry is xvYCC 709, stores 8 when the colorimetry is sYCC 601, stores 9 when the colorimetry is Adobe YCC 601, and stores 10 when the colorimetry is Adobe RGB. Values from 5 to 7 and values from 11 to 15 are reserved values.

The source device 110 typically uses the specific default colorimetry for the video format being transmitted. If no colorimetry is indicated in the CM field 505, then the colorimetry of the transmitted signal matches the default colorimetry for the transmitted video format.

The default colorimetry for all 480 line, 576 line, 240 line and 288 line video formats in the VIC tables 115t and 127t of FIGS. 2 to 4 are based on SMPTE 170M. The default colorimetry for high definition video formats, 720 line and 1080 line in the VIC tables 115t and 127t of FIGS. 2 to 4, is based on ITU709 and for other video format is based on sRGB.

If the sink device 120 does not support xvYCC601, xvYCC709 or sYCC601, then source device 110 is encouraged to transmit video xvYCC-encoded video or sYCC601 and indicates xvYCC601, xvYCC709 or sYCC601 in the CM field 505.

If the CS field 502 indicates either YCbCr444 or YCbCr422, then sink device 120 does not indicate Adobe RGB in the CM field 505.

The default colorimetry for photo mode defined in a CF (Content Flag) field 507 which will be described later is based on sYCC601 and may select one of sYCC601, Adobe YCC601, or Adobe RGB. Although Adobe RGB is a component of the RGB color space, the Adobe RGB value is selected when the CS field 502 value is zero.

If the sink device 120 does not support Adobe YCC601 or Adobe RGB, then source device 110 does not transmit Adobe-encoded photo source and does not indicate Adobe YCC601 or Adobe RGB in the CM field 505.

(9) An AFAR (Active Format Aspect Ratio) field 506 storing data representing the aspect ratio of effective pixels of the video data to be transmitted. The AFAR field 506 stores 0 when the aspect ratio of the effective pixels of the video data is 4:3, stores 10 when the aspect ratio is 16:9, and stores 11 when the aspect ratio is 14:9. Values from 0 to 8 and values from 12 to 15 are reserved values.

(10) The CF (Content Flag) field 507 storing data representing the supported content classification (type). The CF field 507 stores 0 when the content of the video data is default, stores 8 when the content is text, stores 9 when the content is a photo, stores 10 when the content is a cinema, and stores 11 when the content is a game. Values from 1 to 7 and values from 12 to 15 are reserved values.

The values stored in the CF field 507 are based on the content and not on the equipment type. For example, some digital still cameras are able to play back moving pictures, some DVDs are able to play back recorded TV programs and some game players are able to play back movies. However, the type of content stored in the CF field 507 is defined as follows:

Text: set to indicate bit mapped text. The sink device 120 displays the result unfiltered and without analog reconstruction.

Photo: set to indicate still photographs. When the CF field 507 is set to indicate photo, the CM field 505 indicates either sYCC601, Adobe 601 or Adobe RGB and a QR (Quantization Range) field 508 which will be described later indicates full range. The source device 110 does not send content with a colorimetry that is not supported by the sink device 120. The sink device 120 reduces its picture enhancement, and the scaling will be less than or the same as the display resolution.

Cinema: set to indicate cinema source. The sink device 120 reduces its picture enhancements and the sound will be linked with an AV amplifier or TV speaker.

Game: set to indicate game source. The sink device 120 reduces its picture enhancement and the audio latency is minimized.

(11) The QR (Quantization Range) field 508 storing data representing a quantization (bit) range of the video data to be transmitted. The QR field 508 stores 0 when the quantization range is a default quantization range determined according to the video format, stores 1 when the quantization range is a limited range, and stores 2 when the quantization range is a full range.

3 is a reserved value.

The source device 110 does not send video data having a quantization range that is not supported by the sink device 120 to the sink device 120. The allowed values of the quantization ranges in the QR field 508 is restricted for certain video formats. The restrictions are:

RGB video formats: either ‘limited range’ or ‘full range’.

YCbCr video formats: ‘limited range’.

VGA (640x480), sYCC601 and Adobe 601 video formats: ‘full range’.

(12) A D (Detailed Timing Information) field 509 storing 1 when the detailed timing information (DETAILED_TIMING_INFO) is used for timing information of the video data to be transmitted, and stores 0 when the detailed timing information (DETAILED_TIMING_INFO) is not used.

(13) An ID (ID of Detailed Timing Information) field 510 storing an ID of the detailed timing information when 1 is stored in the D field 509, and stores 0 when 0 is stored in the D field 509.

(14) A PM (Partition Mode) field 511 storing data representing a partition mode of the video format. The PM field 511 stores 0b000 when the partition mode is 2x2, stores 0b001 when the partition mode is 1x1, stores 0b010 when the partition mode is 1x2, stores 0b011 when the partition mode is 2x1, stores 0b100 when the partition mode is 2x4, stores 0b101 when the partition mode is 4x2, stores 0b110 when the partition mode is 4x4, and stores 0b111 when the partition mode is 2x2 chroma.

(15) A reserved field 512 reserved for future use.

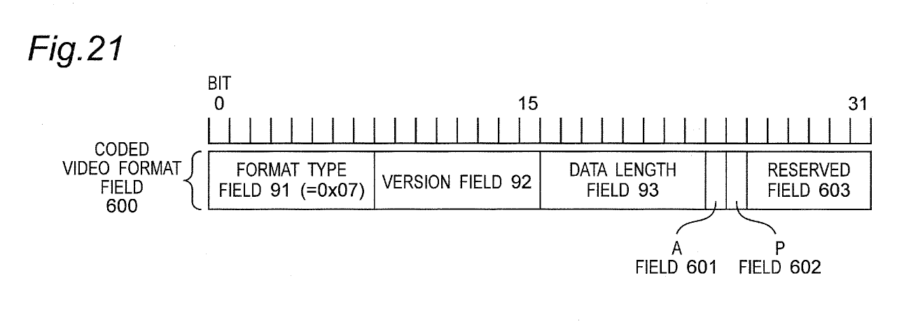

FIG. 21 is a diagram showing a format of the coded video format field 600 included in the stream start notify message 8 of FIG. 18, as the format field 90. Referring to FIG. 21, the coded video format field 600 includes the following fields.

(1) The format type field 91 storing a value (0x07) corresponding to the coded video information.

(2) The version field 92 storing a version number 0x01.

(3) The data length field 93 storing the data representing a total data length of the following fields 601 to 603.

(4) An A (Active) field 601 storing 1 when the video data to be transmitted is coded (compressed), and storing 0 when the video data to be transmitted is not coded (compressed).

(5) A P (Partition Mode) field 602 storing 1 when the partition mode is used, and storing 0 when the partition mode is not used.

(6) A reserved field 603 reserved for future use.

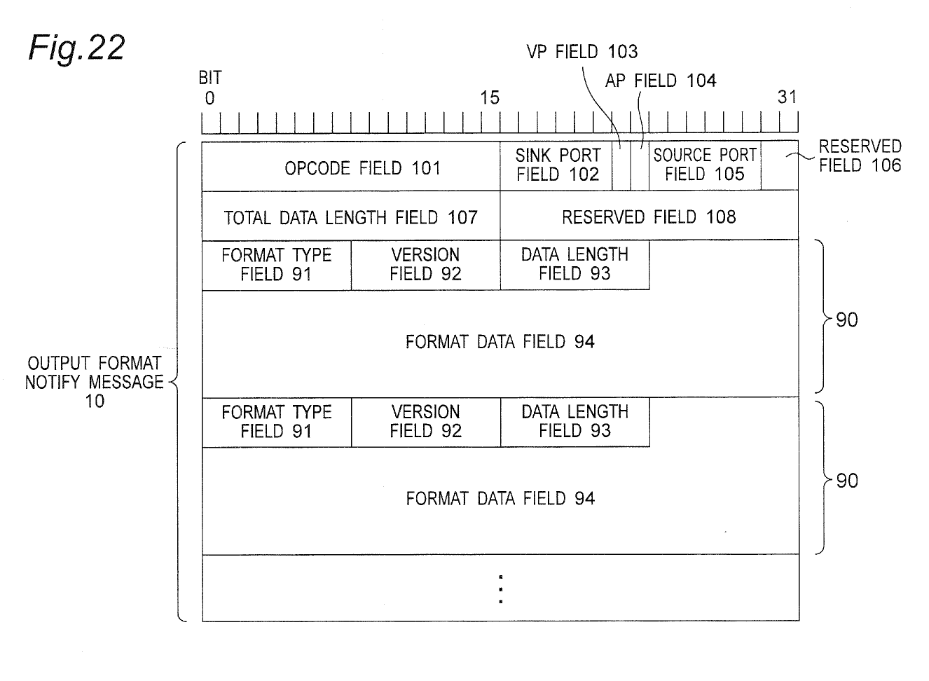

FIG. 22 is a diagram showing a format of the output format notify message 10 of FIG. 5. Before the source device 110 transmits the AV data to the sink device 120 and when at least one of the video format and audio format of the AV data is changed, the source device 110 transmits the output format notify message 10 including the video format and audio format of AV data to be transmitted, to the sink device 120. Referring to FIG. 22, the output format notify message 10 includes the following fields.

(1) An opcode field 101 storing an operation code of the output format notify message 10.

(2) A sink port field 102 storing a sink port number reserved for transmission of the AV data.

(3) A VP field 103 storing 1 when a sink port and a source port are used for the video data, and storing 0 when the sink port and the source port are not used the for video data.

(4) An AP field 104 storing 1 when the sink port and the source port are used for the audio data, and storing 0 when the sink port and the source port are not used for the audio data.

(5) A source port field 105 storing a source port number reserved for transmission of the AV data.

(6) A total data length field 107 storing data representing a data length of fields excluding the opcode field 101 and the total data length field 107 from the output format notify message 10.

(7) Reserved fields 106 and 108 reserved for future use.

(8) At least one format field 90 including the format type field 91, the version field 92, the data length field 93, and the format data field 94.

Referring to FIG. 22, it is to be noted that the format field 90 is configured in a manner similar to that of the format field 90 in the stream start notify message 8 of FIG. 18.

Next, with reference to FIG. 5, there will be described operations of the wireless communication system of FIG. 1 when the source device 110 transmits AV data including compressed video data to the sink device 120. First of all, by storing the data representing the “input format information” in the type field 16 in one sub message 15 in the device capability request message 1 (See FIGS. 6 and 7) and transmitting the device capability request message 1 to the sink device 120, the source device 110 request the sink device 120 to transmit information on input formats supported by the sink device 120. In response this, the sink device 120 transmits the device capability response message 2 (See FIG. 9) including the input format information message 5, which includes the video information message 200 and the coded video information message 400, to the source device 110. In this case, the video information message 200 includes VICs of video formats that are supported by the sink device 120, and are included in the EDID data 127d. In addition, the coded video information message 400 includes the compressing parameters used when the source device 110 compresses the video data by the predetermined first compressing method. In this case, the compressing parameters include data representing a minimum sub-slice size the sink device 120 is able to handle, the maximum value of the number of slices that can be buffered by the sink device 120, and the maximum size of the buffer 129 of the sink device 120 allocated for the compressed video data, and the maximum time length for which the sink device 120 can perform buffering for the compressed video data.

Further, referring to FIG. 5, when the source device 110 receives the device capability response message 2, the source device 110 selects one of the VICs included in the video information message 200 in the received device capability response message 2, and identifies a video format of the selected VIC by referring to the VIC table 115t. In addition, the source device 110 determines whether or not the sink device 120 can decompress the compressed video data, based on whether or not the device capability response message 2 includes the coded video information message 400. Then, the packet processing circuit 113 generates video data having the identified video format, based on the video data from the audio and visual reproducing device 112. Further, the packet processing circuit 113 compresses the generated video data by the predetermined first compressing method, using the compressing parameters included in the received coded video information message 400, to generate the compressed video data. Then, the packet processing circuit 113 converts the compressed video data and inputted audio data into, a digital signal in a form of packets defined by the WirelessHD, and outputs the digital signal to the packet wireless transceiver circuit 114.

Further, referring to FIG. 5, after the width reservation process, the source device 110 transmits the stream start notify message 8 (See FIG. 18) including (a) the video format field 500 (See FIG. 20) including the VIC field 501 storing the VIC for identifying the video format of the compressed video data to be transmitted; and (b) the coded video format field 600 (See FIG. 21) including the A field 601 that stores the value (which is 1) representing that the video data to be transmitted is compressed, to the sink device 120. Then, the source device 110 controls the packet wireless transceiver circuit 114 to wirelessly transmit the digital signal from the packet processing circuit 113, to the sink device 120 as AV data D1.

On the other hand, the sink device 120 identifies the VIC of the video data to be received, based on the video format field 500 in the received stream start notify message 8, and identifies the video format of the video data to be received by referring to the VIC table 127t based on the identified VIC. Further, the sink device 120 identifies that the video data to be received is compressed by the predetermined first compressing method, based on the coded video format field 600 in the stream start notify message 8. Then, in the sink device 120, the packet processing circuit 123 extracts the compressed video data and the audio data from the digital signal received from the source device 110 by a predetermined packet separation process, and decompresses the compressed video data by a predetermined decompressing method corresponding to the predetermined first compressing method used in the source device 110. Further, the packet processing circuit 123 decodes the decompressed video data according to the identified video format, and outputs the decoded video data to the display 126.

In addition, when at least one of the video format and audio format of the AV data D1 is changed, before the source device 110 transmits AV data D2 having the changed video and audio formats to the sink device 120, the source device 110 wirelessly transmits the output format notify message 10 including (a) the video format field 500 (See FIG. 20) including the VIC field 501 storing a VIC for identifying a video format of the compressed video data to be transmitted; and (b) the coded video format field 600 (See FIG. 21) including the A field 601 that stores a value (which is 1) indicating that the video data is compressed, to the sink device 120. In response to this, the sink device 120 identifies the VIC of the video data to be received, based on the output format notify message 10, and identifies that the video data to be received is compressed by the predetermined first compressing method. Then, in the sink device 120, the packet processing circuit 123 extracts the compressed video data and the audio data from the digital signal received from the source device 110 by a predetermined packet separation process, and decompresses the compressed video data by the predetermined decompressing method corresponding to the predetermined first compressing method used in the source device 110. Further, the packet processing circuit 123 decodes the decompressed video data according to the video format of the identified VIC, and outputs the decoded video data to the display 126.

In the WirelessHD according to prior art, since the VICs are not assigned to the 4k2k video data, the sink device 120 cannot notify the source device 110 that the sink device 120 can display the 4k2k video data, using the video information message 200 included in the device capability response message 2. In addition, the source device 110 cannot notify the sink device 120 that the video format of video data to be transmitted is a 4k2k video format, using the stream start notify message 8 or the output format notify message 10. Therefore, it was not possible to wirelessly transmit the 4k2k video data from the source device 110 to the sink device 120.

However, according to the present preferred embodiment, since the VICs of 48 to 52 are assigned to the 4k2k video formats, the sink device 120 can notify the source device 110 that the sink device 120 can display 4k2k video data, using the video information message 200 included in the device capability response message 2. Further, the source device 110 can notify the sink device 120 that the video format of the video data to be transmitted is the 4k2k video format, using the stream start notify message 8 or the output format notify message 10. Therefore, it is possible to wirelessly transmit the 4k2k video data from the source device 110 to the sink device 120.

In addition, the WirelessHD according to prior art is developed to transmit uncompressed video data. However, due to bandwidth constraints in wireless communication, etc., it is difficult to transmit the 4k2k video data as it is without compressing the video data, according to the WirelessHD, and therefore, the video data is required to be compressed. According to the present preferred embodiment, compared with the prior art, since the value (0x07) indicating the coded video information is added to the values stored in the format type field 55 in the input format information message (See FIG. 12), the sink device 120 can transmit the device capability response message 2 to the source device 110, where the device capability response message 2 including the coded video information message 400 including compressing parameters used when the source device 110 compresses video data by the predetermined first compressing method. Therefore, the source device 110 can decompress the video data using the received compressing parameters. Further, compared with the prior art, since the value (0x07) representing the coded video information is added to the values stored in each format type field 91 in the stream start notify message 8 and the output format notify message 10 (See FIG. 19), the source device 110 can notify the sink device 120 that the video data is compressed, using the stream start notify message 8 or the output format notify message 10 including the coded video format field 600. In response to this, the sink device 120 can decompress the received compressed video data. Accordingly, compressed 4k2k video data can be wirelessly transmitted from the source device 110 to the sink device 120.

### Second Preferred Embodiment

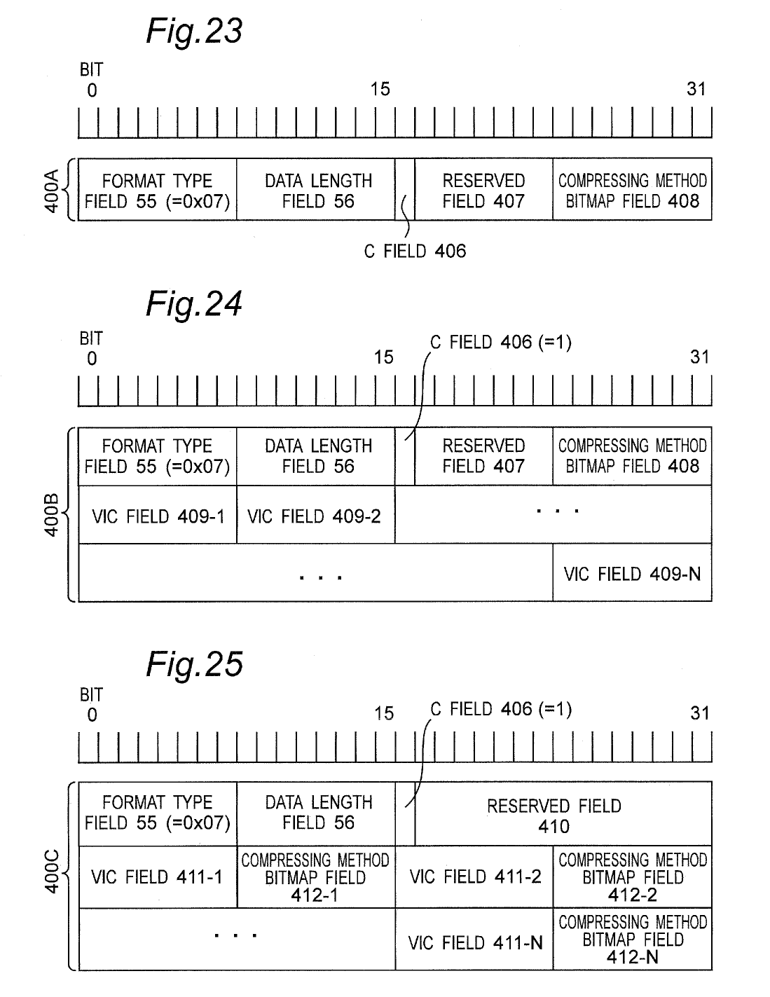

FIG. 23 is a diagram showing a format of a coded video information message 400A according to a second preferred embodiment of the present invention. Referring to FIG. 23, the coded video information message 400A includes the following fields.

(1) The format type field 55 storing the value (0x07) corresponding to the coded video information.

(2) The data length field 56 storing the data representing the data length of the fields excluding the format type field 55 and the data length field 56 from the coded video information message 400A.

(3) A C field 406 storing flag data representing whether or not, when video data having one of at least one predetermined mandatory VIC selected from among the VICs included in the VIC table 127t is compressed by the first, second, or third compressing method, the sink device 120 can decompress the compressed video data. It is to be noted that, in the present preferred embodiment and the following preferred embodiments, mandatory VICs include the VICs (48, 49, 50, 51, and 52) for the 4k2k video formats.

(4) A reserved field 407 reserved for future use.

(5) A compressing method bitmap field 408 storing 8-bit bitmap data representing at least one compressing method (codec) supported by the sink device 120. Bit 0 of the bitmap data, which represents the compressing method, is assigned to the first compressing method, bit 1 is assigned to the second compressing method, and bit 2 is assigned to the third compressing method. Bits 3 to 8 are reserved bits. When the value of a bit of the bitmap data representing a compressing method is set to 1, it indicates that the sink device 120 can decompress compressed video data which is compressed by a compressing method corresponding to the bit. On the other hand, when the value of a bit is set to 0, it indicates that the sink device 120 cannot decompress compressed video data which is compressed by a compressing method corresponding to the bit.

The sink device 120 cannot notify the source device 110 of VICs and compressing methods for compressed video data that can be decompressed by the sink device 120, using the coded video information message 400 according to the first preferred embodiment. However, according to the present preferred embodiment, since the coded video information message 400A includes the C field 406 and the compressing method bitmap field 408, the sink device 120 can notify the source device 110 whether or not the sink device 120 can decompress respective compressed video data which are obtained by compressing video data having the above-described mandatory VICs by the first to third compressing methods, by setting the value of the flag data stored in the C field 406 to 1.

### Third Preferred Embodiment

FIG. 24 is a diagram showing a format of a coded video information message 400B according to a third preferred embodiment of the present invention. As compared with the coded video information message 400A according to the second preferred embodiment, the coded video information message 400B of the present preferred embodiment is characterized by further including VIC fields 409-1, 409-2, . . . , 409-N (N is an integer equal to or larger than 1) each storing a VIC of compressed video data which can be decompressed by the sink device 120, where the compressed video data is compressed by the compressing method supported by the sink device 120 and indicated by the bitmap data stored in the compressing method bitmap field 408. Referring to FIG. 24, it is to be noted that the C field 406 stores flag data (1) when the sink device 120 can decompress at least one compressed video data having one of the VICs included in the VIC table 127t and is compressed by the first, second, or third compressing method. The C field 406 stores flag data (0) when the sink device 120 cannot decompress all of the compressed video data having one of the VICs included in the VIC table 127t and are compressed by the first, second, or third compressing method.

In the second preferred embodiment, the sink device 120 can notify the source device 110 of only compressing methods for compressed video data having the mandatory VICs which can be decompressed by the sink device 120, using the coded video information message 400A. On the other hand, according to the present preferred embodiment, using the coded video information message 400B, the sink device 120 can notify the source device 110 of compressing methods of the compressed video data which can be decompressed by the sink device 12, where the respective compressed video data have any one of the VICs included in the VIC table 127t.

### Fourth Preferred Embodiment

FIG. 25 is a diagram showing a format of a coded video information message 400C according to a fourth preferred embodiment of the present invention. The coded video information message 400C according to the present preferred embodiment is different from the coded video information message 400B according to the third preferred embodiment in the following points:

(1) Instead of the reserved field 407 and the compressing method bitmap field 408, the coded video information message 400C includes a reserved field 410 reserved for future use.

(2) Instead of VIC fields 409-1 to 409-N, the coded video information message 400C includes N VIC fields 411-n (n=1, 2, . . . , N), and compressing method bitmap fields 412-n (n=1, 2, . . . , N) provided so as to correspond to VIC fields 411-n, respectively.

Referring to FIG. 25, it is to be noted that the C field 406 stores flag data (1) when the sink device 120 can decompress compressed video data, and stores flag data (0) when the sink device 120 cannot decompress the compressed video data. In addition, each compressing method bitmap field 412-n stores bitmap data representing a compressing method for compressed video data, which has a VIC stored in a corresponding VIC field 411-n and is supported by the sink device 120. In this case, the bitmap data stored in the VIC field 411-n is configured in a manner similar to that of the bitmap data stored in the compressing method bitmap fields 408 shown in FIGS. 23 and 24.

As compared with the third preferred embodiment, the coded video information message 400C according to the present preferred embodiment further includes N sets of the VIC fields 411-n and the compressing method bitmap fields 412-n. Therefore, even when the sink device 120 supports different compressing methods for different VICs, the sink device 120 can notify the source device 110 of all of combinations of VICs and compressing methods for compressed video data supported by the sink device 120.

### Fifth Preferred Embodiment

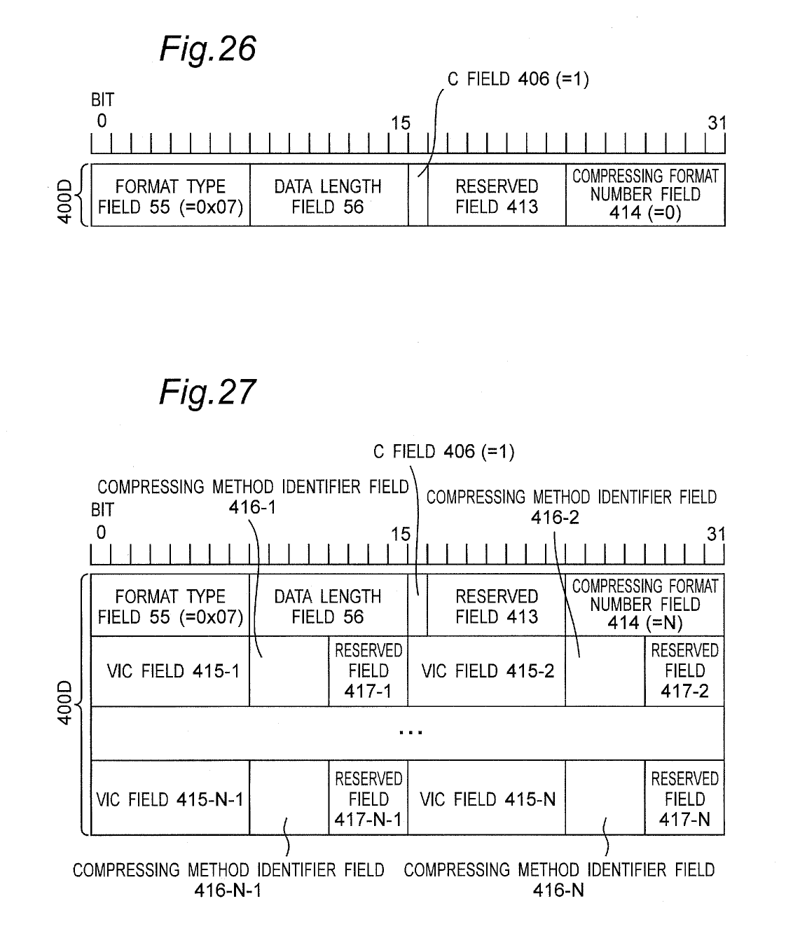

FIG. 26 is a diagram showing a format of a coded video information message 400D according to a fifth preferred embodiment of the present invention, when the C field stores 1 and a compressing format number field 414 stores 0. In addition, FIG. 27 is a diagram showing a format of the coded video information message 400D according to the fifth preferred embodiment of the present invention, when the C field stores 1 and the compressing format number field 414 stores N. Referring to FIGS. 26 and 27, the coded video information messages 400D include the following fields in addition to the format type field 55, the data length field 56, and the C field 406 in the coded video information message 400C of FIG. 25.

(1) A reserved field 413 reserved for future use.

(2) The compressing format number field 414 storing a total number N of combinations of VICs and compressing methods for compressed video data which can be decompressed by the sink device 120.

(3) N sets of VIC fields 415-n (n=1, 2, . . . , N), compressing method identifier fields 416-n and reserved fields 417-n, where the compressing method identifier fields 416-n and reserved fields 417-n are provided so as to correspond to the VIC fields 415-n, respectively. In this case, each VIC field 415-n stores a VIC of compressed video data which can be decompressed by the sink device 120. In addition, each compressing method identifier field 416-n stores a compressing method identifier for identifying a compressing method supported by the sink device 120 among compressing methods for compressed video data having a VIC stored in the corresponding VIC field 415-n.

In this case, the compressing method identifier is defined as follows:

Not compressed: compressing method identifier=0b0000;

First compressing method: compressing method identifier=0b0001;

Second compressing method: compressing method identifier=0b0010;

Third compressing method: compressing method identifier=0b0011; and

Compressing method identifiers 0b0100 to 0b1111 are compressing method identifiers reserved for future use.

When the sink device 120 cannot decompress any compressed video data, the C field 406 is set to 0. In addition, when the sink device 120 can decompress only compressed video data, which have the above-mentioned mandatory VICs and is compressed by a predetermined mandatory compressing method, the C field 406 is set to 1 and the compressing format number field 414 is set to 0, as shown in FIG. 26. In this case, in the present preferred embodiment and the following preferred embodiments, the mandatory compressing method is the first compressing method.

Further, when the sink device 120 can decompress compressed video data compressed by the mandatory compressing method and compressed video data compressed by the second or third compressing method which is specified as other options, the compressing format number field 414 stores an integer N equal to or larger than 1, as shown in FIG. 27.

As described above, according to the present preferred embodiment, the sink device 120 can notify the source device 110 that the sink device 120 can decompress the compressed video data, and can notify the source device 110 of all of the combinations of the VICs and the compressing method identifiers of compressed video data which can be decompressed by the sink device 120, using the coded video information message 400D.

### Sixth Preferred Embodiment

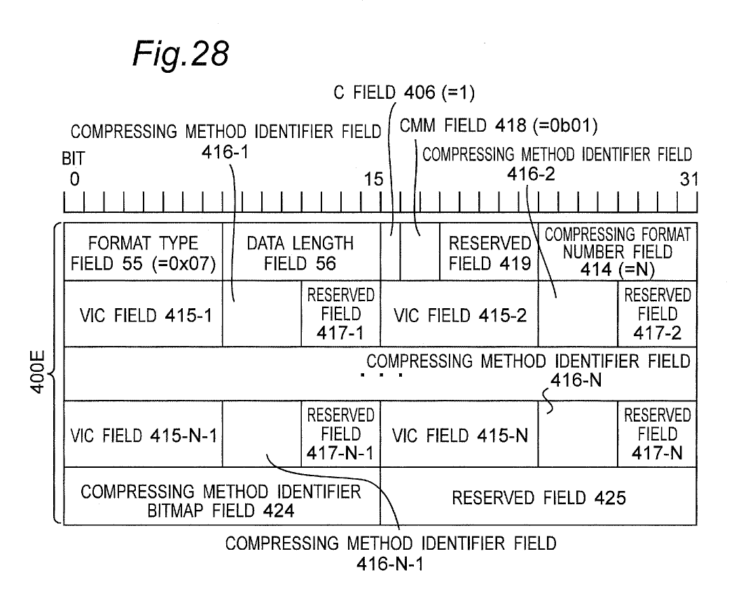

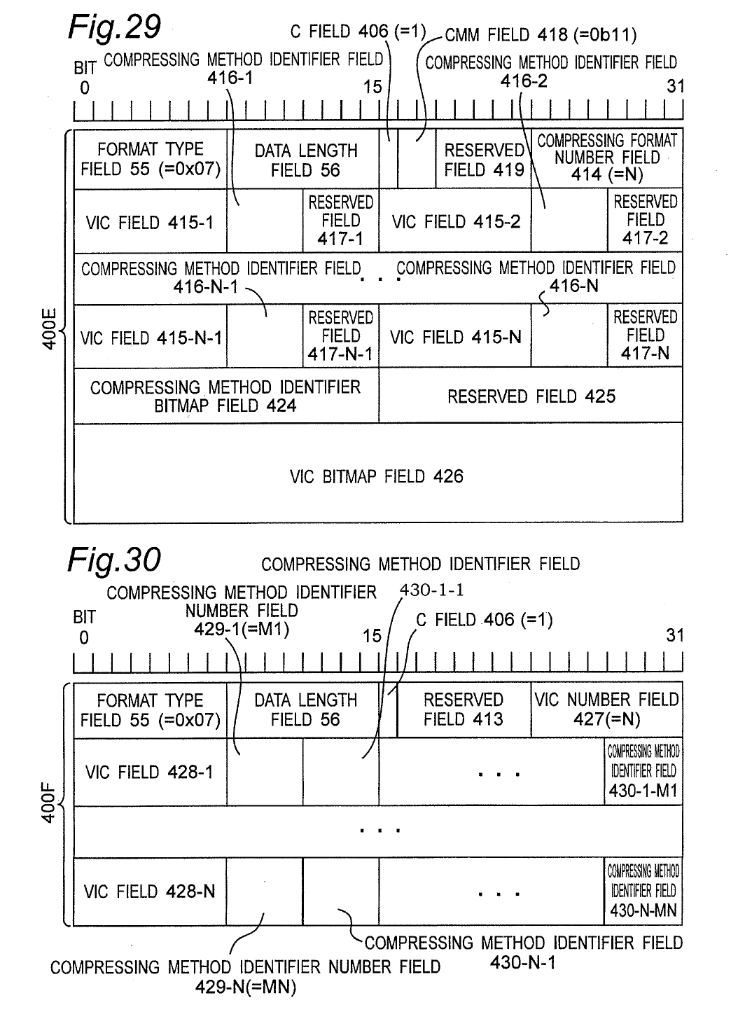

FIG. 28 is a diagram showing a format of a coded video information message 400E according to a sixth preferred embodiment of the present invention, when a CMM (Compression Method Multiple) field 418 stores 0b01. In addition, FIG. 29 is a diagram showing a format of the coded video information message 400E according to the sixth preferred embodiment of the present invention, when the CMM field 418 stores 0b11.

The coded video information message 400E according to the present preferred embodiment is different from the coded video information message 400D according to the fifth preferred embodiment in the following points:

(1) Instead of a reserved field 413, the coded video information message 400E includes a CMM field 418 storing data representing whether or not the coded video information message 400E includes the following VIC bitmap field 426, and a reserved field 419.

(2) When the CMM field 418 stores 0b01, the coded video information message 400E further includes a compressing method identifier bitmap field 424 and a reserved field 425, and when the CMM field 418 stores 0b11, the coded video information message 400E further includes a compressing method identifier bitmap field 424, a reserved field 425, and the VIC bitmap field 426.

As shown in FIG. 28, when the CMM field 418 stores 0b01, the compressing method identifier bitmap field 424 stores bitmap data representing a commonly supported compressing method for compressed video data having VICs stored in all of the VIC fields 415-1 to 415-N. In this case, the above-mentioned compressing method identifiers are assigned to the respective bits of the bitmap data stored in the compressing method identifier bitmap field 424. In addition, when the value of a bit of the bitmap data is set to 1, it indicates that a compressing method corresponding to the bit is supported. On the other hand, when the value of a bit is set to 0, a compressing method corresponding to the bit is not supported.

In addition, as shown in FIG. 29, when the CMM field 418 stores 0b11, the coded video information message 400E further includes a VIC bitmap field 426. In this case, the VIC bitmap field 426 stores bitmap data representing a commonly supported VIC for compressed video data compressed by compressing methods which correspond to bits of bitmap data stored in the compressing method identifier bitmap field 424 where 1 is set, respectively. In this case, the values of the VICs included in the VIC table 127t (See FIGS. 2, 3, and 4) are assigned to the respective bits of the bitmap data stored in the VIC bitmap field 426 in descending order. In this case, the sink device 120 notifies the source device 110 that compressing methods whose corresponding bits in the compressing method bitmap identifier field 424 are set to 1 are supported for video data having the VICs corresponding to bits in the VIC bitmap field 426 where 1 is set, using the coded video information message 400E of FIG. 29.

As described above, according to the present preferred embodiment, the sink device 120 can notify the source device 110 that the sink device 120 can decompress compressed video data, and can notify the source device 110 of all of the combinations of the VICs and the compressing method identifiers of the compressed video data which can be decompressed by the sink device 120, using the coded video information message 400E.

### Seventh Preferred Embodiment

FIG. 30 is a diagram showing a format of a coded video information message 400F according to a seventh preferred embodiment of the present invention. The coded video information message 400F according to the present preferred embodiment is different from the coded video information message 400D according to the fifth preferred embodiment (See FIG. 27) in the following points:

(1) Instead of the compressing format number field 414, the coded video information message 400D includes a VIC number field 427 storing the total number N of the VICs of the compressed video data which can be decompressed by the sink device 120.

(2) Instead of N sets of the VIC fields 415-n, the compressing method identifier fields 416-n, and the reserved fields 417-n, the coded video information message 400D includes VIC fields 428-1, . . . , 428-N, compressing method identifier number fields 429-1, . . . , 429-N, and compressing method identifier fields 430-1-1, . . . , 430-1-M1, . . . , 430-N−1, . . . , 430-N-MN. The VIC fields 428-1, . . . , 428-N store N VICs of compressed video data which can be decompressed by the sink device 120, respectively. The compressing method identifier number fields 429-1, . . . , 429-N are provided so as to correspond to the VIC fields 428-1, . . . , 428-N, respectively. The compressing method identifier fields 430-1-1, . . . , 430-1-M1, . . . , 430-N−1, . . . , 430-N-MN are provided after the respective compressing method identifier number fields 429-1, . . . , 429-N, and the respective numbers of the compressing method identifier fields 430-1-1, . . . , 430-1-M1, . . . , 430-N−1, . . . , 430-N-MN are the same as numbers M1, . . . , MN stored in the compressing method identifier number fields 429-1, . . . , 429-N, respectively.

Referring to FIG. 30, the VIC number field 427 stores a total number N of VICs of compressed video data which can be decompressed by the sink device 120. In addition, the VIC fields 428-1, . . . , 428-N store the VICs of compressed video data which can be decompressed by the sink device 120, respectively. Each of the compressing method identifier number fields 429-n (n=1, 2, . . . , N) stores a value Mn indicating the number of compressing method identifiers that follow the compressing method identifier number fields 429-n. Each of the compressing method identifier fields 430-n-mn (m=1, 2, . . . , M) stores a compressing method identifier of a compressing method supported by the sink device 120 among compressing methods of compressed video data having the VIC stored in a corresponding VIC field 428-n. It is to be noted that in the present preferred embodiment, the compressing method identifiers are defined in a manner similar to that of the fifth preferred embodiment.

As described above, according to the present preferred embodiment, the sink device 120 can notify the source device 110 that the sink device 120 can decompress compressed video data, and can notify the source device 110 of all of the combinations of the VICs and the compressing method identifiers of the compressed video data which can be decompressed by the sink device 120, using the coded video information message 400F.

### Eighth Preferred Embodiment

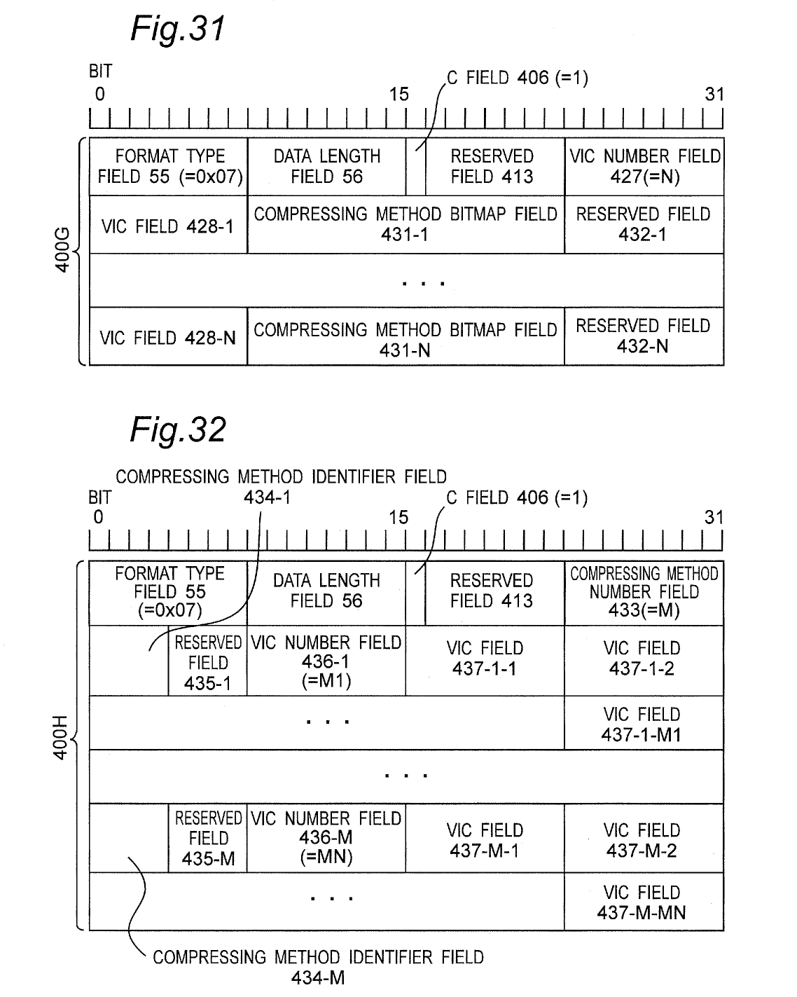

FIG. 31 is a diagram showing a format of a coded video information message 400G according to an eighth preferred embodiment of the present invention. The coded video information message 400G according to the present preferred embodiment is different from the coded video information message 400F according to the seventh preferred embodiment in that the coded video information message 400G includes compressing method bitmap fields 431-1, . . . , 431-N and reserved fields 432-1, . . . , 432-N instead of the compressing method identifier number fields 429-n (n=1, 2, . . . , N) and the compressing method identifier fields 430-n-mn (m=1, 2, . . . , M). The compressing method bitmap fields 431-1, . . . , 431-N and the reserved fields 432-1, . . . , 432-N are provided so as to correspond to the VIC fields 428-1, . . . , 428-N, respectively.

Referring to FIG. 31, each compressing method bitmap field 431-n (n=1, 2, . . . , N) stores bitmap data representing a compressing method supported by the sink device 120 among compressing methods for compressed video data of a VIC stored in a corresponding VIC field 428-n. The bitmap data stored in the compressing method bitmap fields 431-n is configured in a manner similar to that of the bitmap data stored in the compressing method bitmap fields 412-n of FIG. 25.

As described above, according to the present preferred embodiment, the sink device 120 can notify the source device 110 that the sink device 120 can decompress compressed video data, and can notify the source device 110 of all of the combinations of the VICs and the compressing method identifiers of the compressed video data which can be decompressed by the sink device 120, using the coded video information message 400G.

### Ninth Preferred Embodiment

FIG. 32 is a diagram showing a format of a coded video information message 400H according to a ninth preferred embodiment of the present invention. The present preferred embodiment is different from the coded video information message 400D according to the fifth preferred embodiment in the following points:

(1) Instead of the compressing format number field 414, the coded video information message 400D includes a compressing method number field 433 storing a total number M of compressing methods for compressed video data which can be decompressed by the sink device 120.

(2) Instead of N sets of the VIC fields 415-n, the compressing method identifier fields 416-n, and the reserved fields 417-n, the coded video information message 400D includes compressing method identifier fields 434-1, . . . , 434-M, reserved fields 435-1, . . . , 435-M, VIC number fields 436-1, . . . , 436-M, and VIC fields 437-1-1, . . . , 437-1-M1, . . . , 437-N−1, . . . , 437-N-MN. The compressing method identifier fields 434-1, . . . , 434-M store compressing method identifiers of the compressing methods for compressed video data which can be decompressed by the sink device 120, respectively. The reserved fields 435-1, . . . , 435-M are provided so as to correspond to the compressing method identifier fields 434-1, . . . , 434-M, respectively. The VIC number fields 436-1, . . . , 436-M are provided are provided so as to correspond to the compressing method identifier fields 434-1, . . . , 434-M, respectively. The VIC fields 437-1-1, . . . , 437-1-M1, . . . , 437-N−1, . . . , 437-N-MN are provided after the respective VIC number fields 436-1, . . . , 436-M, and the respective numbers of the VIC fields 437-1-1, . . . , 437-1-M1, . . . , 437-N−1, . . . , 437-N-MN are the same as numbers M1, . . . , MN stored in the VIC number fields 436-1, . . . , 436-M, respectively.

Referring to FIG. 32, the compressing method number field 433 stores a total number M of compressing methods for compressed video data which can be decompressed by the sink device 120. In addition, the compressing method identifier fields 434-m store compressing method identifiers, which are defined in a manner similar to that of the fifth preferred embodiment, of the compressing methods for compressed video data which can be decompressed by the sink device 120, respectively. Each VIC number field 436-m stores a total number Mn of VICs supported by the sink device 120 among VICs of compressed video data compressed by a compressing method corresponding to a value stored in a corresponding compressing method identifier field 434-m. Further, each VIC field 437-m-mn stores a VIC supported by the sink device 120 among VICs of compressed video data compressed by a compressing method corresponding to a value stored in a corresponding compressing method identifier field 434-m.

As described above, according to the present preferred embodiment, the sink device 120 can notify the source device 110 that the sink device 120 can decompress compressed video data, and can notify the source device 110 of all of the combinations of the VICs and the compressing method identifiers of the compressed video data which can be decompressed by the sink device 120, using the coded video information message 400H.

### Tenth Preferred Embodiment

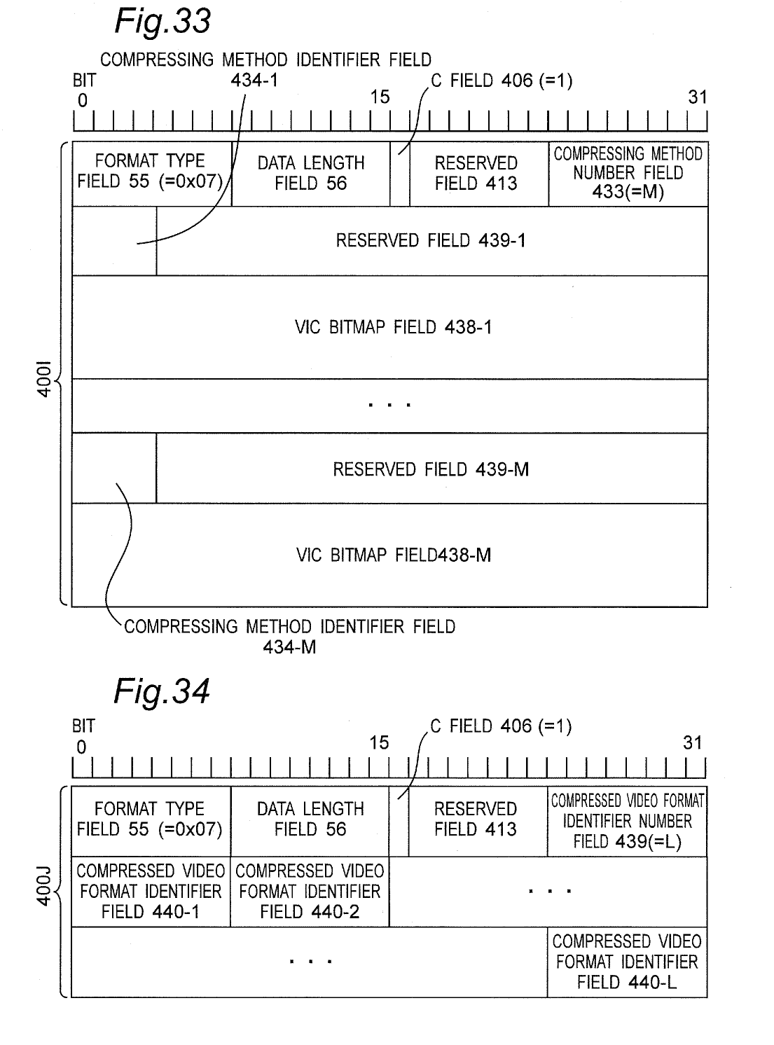

FIG. 33 is a diagram showing a format of a coded video information message 400I according to a tenth preferred embodiment of the present invention. The present preferred embodiment is different from the coded video information message 400H according to the ninth preferred embodiment in that the coded video information message 400I includes reserved fields 439-m and VIC bitmap fields 438-m which are provided so as to correspond to the compressing method identifier fields 434-m (m=1, 2, . . . , M), respectively.

Referring to FIG. 33, each VIC bitmap field 438-m stores bitmap data representing a VIC supported by the sink device 120 among VICs of compressed video data compressed by the compressing method corresponding to the value stored in the corresponding compressing method identifier field 434-m. In this case, the bitmap data stored in the VIC bitmap fields 438-m is configured in a manner similar to that of the bitmap data stored in the VIC bitmap field 426 (See FIG. 29) in the sixth preferred embodiment.

As described above, according to the present preferred embodiment, the sink device 120 can notify the source device 110 that the sink device 120 can decompress compressed video data, and can notify the source device 110 of all of the combinations of the VICs and the compressing method identifiers of the compressed video data which can be decompressed by the sink device 120, using the coded video information message 400I.

### Eleventh Preferred Embodiment

FIG. 34 is a diagram showing a format of a coded video information message 400J according to an eleventh preferred embodiment of the present invention. The present preferred embodiment is different from the coded video information message 400D according to the fifth preferred embodiment in the following points:

(1) Instead of the compressing format number field 414, the coded video information message 400J includes a compressed video format identifier number field 439 storing a total number L of combinations of compressing methods and VICs of compressed video data which can be decompressed by the sink device 120.

(2) Instead of N sets of the VIC fields 415-n, the compressing method identifier fields 416-n, and the reserved fields 417-n, the coded video information message 400J includes compressed video format identifier fields 440-1, . . . , 440-L that store compressed video format identifiers (referred to as compressing VICs hereinafter), respectively. The coding VICs identify the combinations of compressing methods and VICs.

In the present preferred embodiment, one compressing VIC is assigned to each combination of a compressing method and a VIC. In the present preferred embodiment, the compressing VIC is defined as follows:

Compressing VIC=“1”: the compressing method is the first compressing method and the VIC is 48 (3840x2160p and 23.97/24 Hz).

Compressing VIC=“2”: the compressing method is the first compressing method and the VIC is 49 (3840x2160p and 25 Hz).

Compressing VIC=“3”: the compressing method is the first compressing method and the VIC is 50 (3840x2160p and 29.97/30 Hz).

Compressing VIC=“4”: the compressing method is the first compressing method and the VIC is 51 (4096x2160p and 23.97/24 Hz). Compressing VIC=“5”: the compressing method is the first compressing method and the VIC is 52 (4096x2160p and 25 Hz).

The sink device 120 stores the values of L compressing VICs supported by the sink device 120 among the above-described compressing VICs, in the compressing VIC fields 440-1, . . . , 440-L, respectively.

In addition, the compressing VICs may be redefined as VICs shown in FIGS. 2, 3, and 4. For example, VICs 48 to 52 may be assigned to VICs for video data compressed by the first compressing method, respectively. For example, VICs for compressed video data may be assigned as follows:

VIC=“48”: 3840x2160p, 23.97/24 Hz, and the first compressing method;

VIC=“49”: 3840x2160p, 25 Hz, and the first compressing method;

VIC=“50”: 3840x2160p, 29.97/30 Hz, and the first compressing method;

VIC=“51”: 4096x2160p, 23.97/24 Hz, and the first compressing method; and

VIC=“52”: 4096x2160p, 25 Hz, and the first compressing method.

In this case, when the sink device 120 supports the first compressing method, the sink device 120 stores values from 48 to 52 in VIC fields 207-1, 207-2, . . . , 207-N, respectively, where the VIC fields 207-1, 207-2, . . . , 207-N (See FIG. 13) are included in the video information message 200 in the device capability response message 2. The sink device 120 transmits the device capability response message 2 to the source device 110. The source device 110 detects that 48 to 52 are stored in the VIC fields 207-1, 207-2, . . . , 208-N in the video information message 200 in the device capability response message 2, and transmits compressed video data of content data compressed by the first compressing method to the sink device 120.

As described above, according to the present preferred embodiment, the sink device 120 can notify the source device 110 that the sink device 120 can decompress compressed video data, and can notify the source device 110 of all of the combinations of the VICs and the compressing method identifiers of the compressed video data which can be decompressed by the sink device 120, using the coded video information message 400J.

### Twelfth Preferred Embodiment

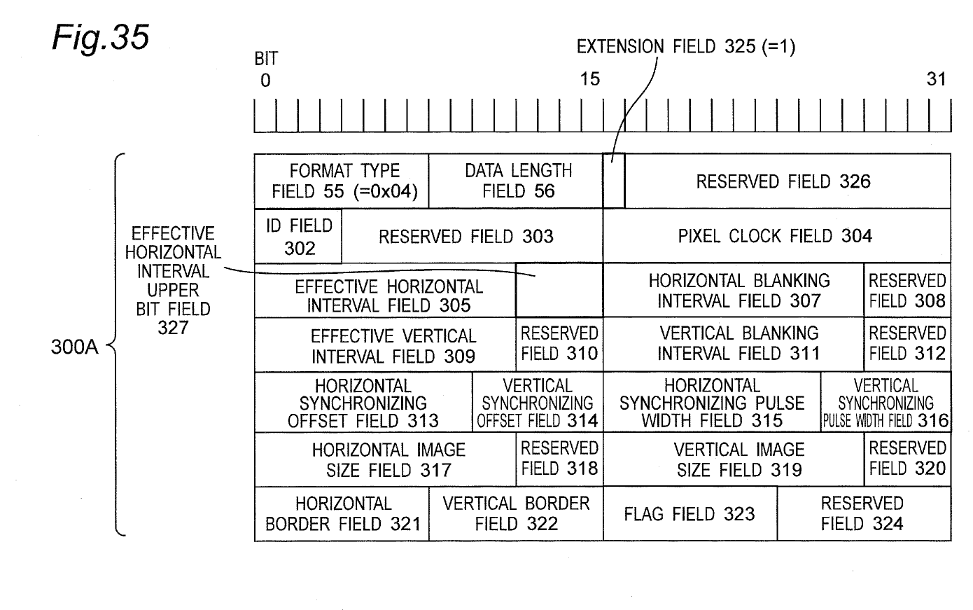

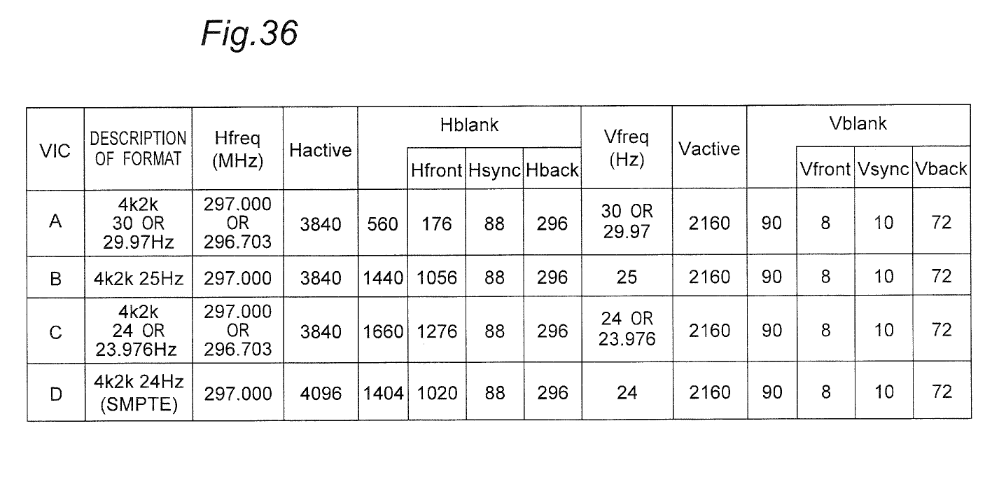

FIG. 35 is a diagram showing a format of a detailed timing information message 300A according to a twelfth preferred embodiment of the present invention. In addition, FIG. 36 is a table showing a relation between VICs for the 4k2k video formats, and timing values used in the twelfth and thirteenth preferred embodiments of the present invention. It is to be noted that four VICs of FIG. 36 are assigned to reserved VICs in VIC tables 115t and 127t shown in FIGS. 2 to 4. In addition, each timing value of FIG. 36 is used when the 4k2k video data is transmitted between the source device 110 and the sink device 120 or between ICs (Integrated Circuits) in the sink device 120. The detailed timing information message 300A according to the present preferred embodiment is different from the detailed timing information message 300 according to the first preferred embodiment (See FIG. 14) in that the detailed timing information message 300A includes an extension field 325 and a reserved field 326 instead of the reserved field 301, and includes an effective horizontal interval upper bit field 327 instead of the reserved field 306.

Referring to FIG. 35, the extension field 325 stores data representing whether or not the effective horizontal interval field 305 that stores the number of effective pixels in the effective horizontal interval Hactive is extended to the effective horizontal interval upper bit field 327 (whether or not data stored in the effective horizontal interval upper bit field 327 is valid). When 0 is stored in the extension field 325, the effective horizontal interval field 305 is not extended to the effective horizontal interval upper bit field 327, and stores the number of effective pixels in the effective horizontal interval Hactive as 12-bit data. In this case, the data stored in the effective horizontal interval upper bit field 327 is ignored. On the other hand, when 1 is stored in the extension field 325, the effective horizontal interval field 305 is extended to the effective horizontal interval upper bit field 327, and stores the lower 12 bits of the data on the number of effective pixels in the effective horizontal interval Hactive, and the effective horizontal interval upper bit field 327 stores the data of the upper 4 bits of the number of effective pixels in the effective horizontal interval Hactive.

According to the detailed timing information message 300 according to the first preferred embodiment, since the size of the effective horizontal interval field 305 is 12 bits, the sink device 120 can notify the source device 110 of only the number of effective pixels in the effective horizontal interval Hactive having a value from 0 to 4095 pixels. Therefore, when the number of effective pixels in the effective horizontal interval is 4096, as in the 4k2k video format of VIC (D) of FIG. 36, the sink device 120 cannot notify the source device 110 of the number of effective pixels, using the detailed timing information message 300. However, according to the present preferred embodiment, the lower 12-bit numeric values “000000000000 (12 “0s”)” of 13-bit numeric values “1000000000000 (the lower 12 bits are “0s”)” representing 4096 in binary are stored in the effective horizontal interval field 305, and the upper bit numeric values “0001 (the upper 3 bits are “0s” and the lowest bit is “1”)” is stored in the effective horizontal interval upper bit field 327. Therefore, according to the present preferred embodiment, even if the number of bits for the number of effective pixels in the effective horizontal interval Hactive is 13 bits or more, the sink device 120 can notify the source device 110 of the number of effective pixels.

### Thirteenth Preferred Embodiment

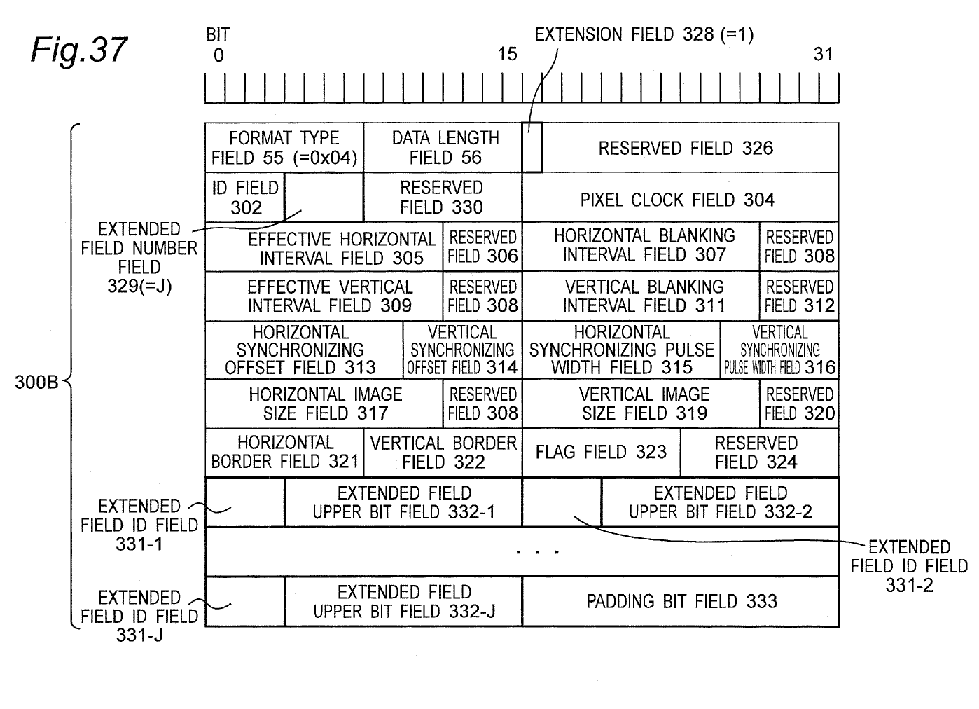

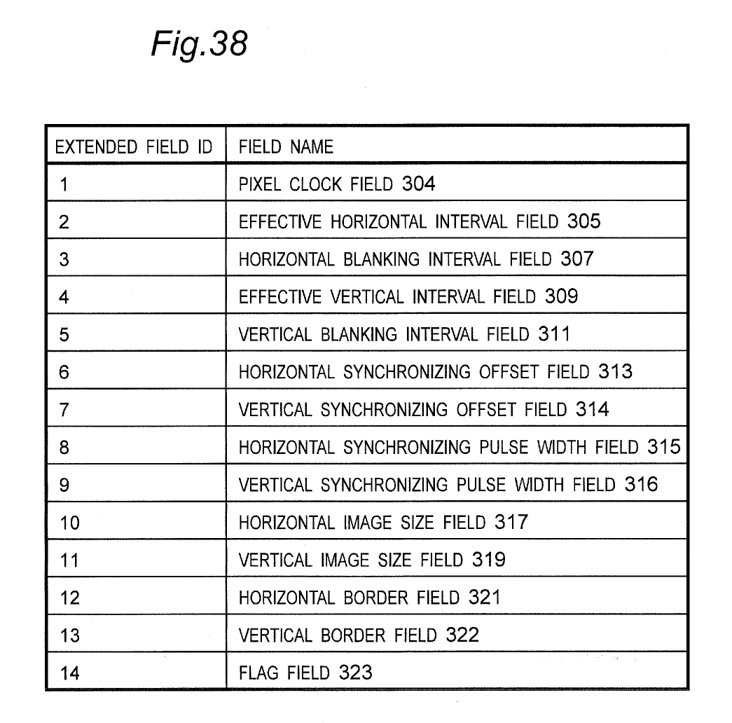

FIG. 37 is a diagram showing a format of a detailed timing information message 300B according to a thirteenth preferred embodiment of the present invention. In addition, FIG. 38 is a table showing a relation between extended field IDs stored in extended field ID fields 331-1 to 331-J of FIG. 37, and field names. The detailed timing information message 300B according to the present preferred embodiment is different from the detailed timing information message 300 according to the first preferred embodiment (See FIG. 14) in the following points:

(1) Instead of the reserved field 301, the detailed timing information message 300B includes an extension field 328 and a reserved field 326. The extension field 328 stores 1 when at least one of the fields 304, 305, 307, 309, 311, 313, 314, 315, 316, 317, 319, 321, 322, and 323 in the detailed timing information message 300B is extended, and stores 0 when none of the fields 304, 305, 307, 309, 311, 313, 314, 315, 316, 317, 319, 321, 322, and 323 is extended.

(2) Instead of the reserved field 303, the detailed timing information message 300B includes an extended field number field 329 and a reserved field 330. The extended field number field 329 stores a number J (J is an integer equal to or larger than 1) of extended fields among the fields 304, 305, 307, 309, 311, 313, 314, 315, 316, 317, 319, 321, 322, and 323 that store detailed timing information.

(3) The detailed timing information message 300B further includes extended field ID fields 331-j (j=1, 2, . . . , J) and extended field upper bit fields 332-j. The extended field ID fields 331-j store IDs of the extended fields, respectively. The extended field upper bit fields 332-j are provided so as to correspond to the extended field ID fields 331-j, respectively. Each of the extended field upper bit fields 332-j stores upper bit data of data stored in a corresponding extended field.

(4) The detailed timing information message 300B further includes a padding bit field 333 for adjusting the message length of the detailed timing information message 300B to an integer multiple of 32 bits.

As shown in FIG. 38, unique extended fields IDs 1 to 14 are assigned to the fields 304, 305, 307, 309, 311, 313, 314, 315, 316, 317, 319, 321, 322, and 323, respectively.

There will be described operations of the wireless communication system of FIG. 1 when the sink device 120 transmits detailed timing information of VIC (D) of FIG. 36 to the source device 110 using the detailed timing information message 300B. In this case, the field to be extended is only the effective horizontal interval field 305 that stores the number of effective pixels (4096) in the effective horizontal interval Hactive. In this case, the extension field stores 1, the extended field number field 329 stores 1, and the extended field ID field 331-1 stores extended field ID of 2 (See FIG. 38). Further, the effective horizontal interval field 305 stores the lower 12-bit numeric values “000000000000 (12 “0s”)” of 13-bit numeric values “1000000000000 (the lower 12 bits are “0s”)” representing 4096 in binary, and the extended field upper bit field 332-1 stores the upper bit numeric values “000000000001 (the upper 11 bits are “0s” and the lowest bit is “1”)” of the 13-bit numeric values representing 4096 in binary. Therefore, the sink device 120 can transmit the number of effective pixels in the effective horizontal interval Hactive to the source device 110, using the detailed timing information message 300B, as 24-bit data “000000000001000000000000 (the upper 11 bits are “0s”, the 12th bit is “1”, and the lower 12 bits are “0s”)”.

In the detailed timing information message 300A according to the twelfth preferred embodiment, only the effective horizontal interval field 305 is extended. However, since the size of the horizontal synchronizing offset field 313 is 10 bits, the sink device 120 can notify the source device 110 of only the number of pixels in the horizontal synchronizing pulse front interval (horizontal synchronizing offset interval) Hfront having a value from 0 to 1023 pixels. As compared with the twelfth preferred embodiment, the present preferred embodiment has advantageous action and effects that all of the fields 304, 305, 307, 309, 311, 313, 314, 315, 316, 317, 319, 321, 322, and 323 that store the detailed timing information can be extended.

### Fourteenth Preferred Embodiment

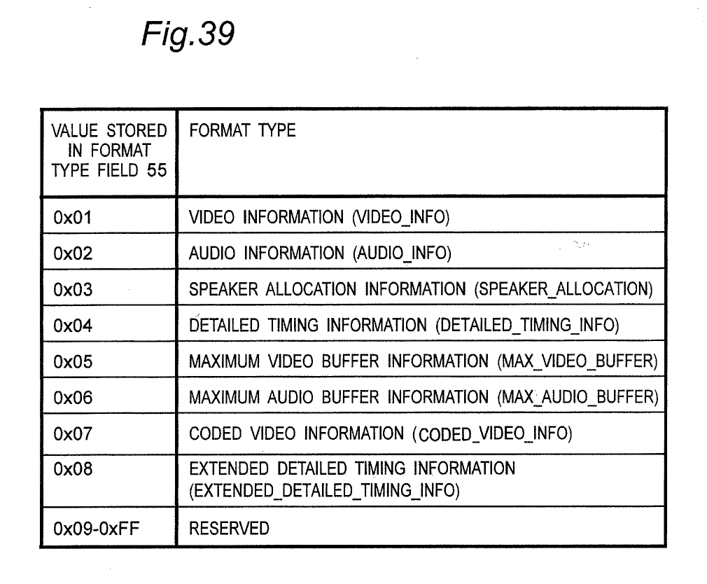

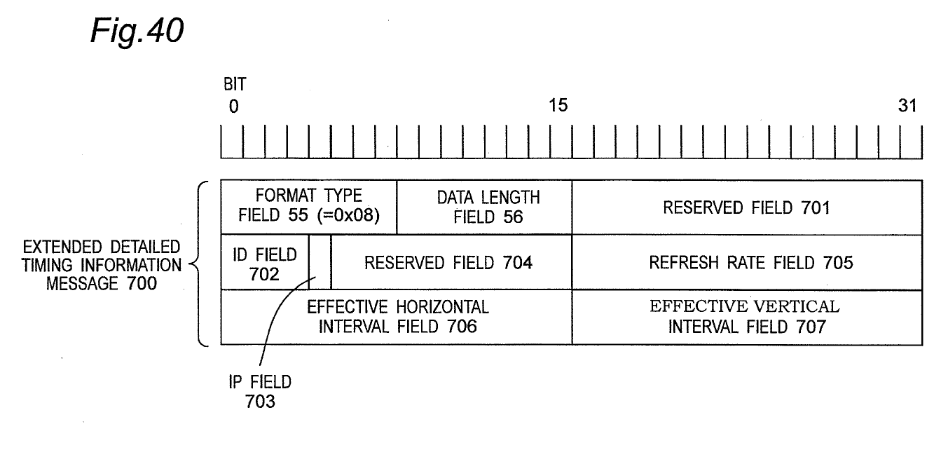

FIG. 39 is a table showing a relation between values stored in the format type field 55 in the input format information message 5 of FIG. 11, and format types in a fourteenth preferred embodiment of the present invention. In addition, FIG. 40 is a diagram showing a format of an extended detailed timing information message 700 according to the fourteenth preferred embodiment of the present invention. As shown in FIG. 39, compared with the first preferred embodiment (See FIG. 12), the present preferred embodiment is characterized in that the value (0x08) indicating extended detailed timing information (EXTENDED_DETAILED_TIMING_INFO) is added to data on the format types stored in the format type field 55 in the input format information message 5. In this case, in the present preferred embodiment, a format data message 54 including the format type field 55 that stores the value (0x08) corresponding to the extended detailed timing information is referred to as an extended detailed timing information message 700.

Referring to FIG. 40, the extended detailed timing information message 700 includes the following fields:

(1) The format type field 55 storing the value (0x08) corresponding to the extended detailed timing information.

(2) The data length field 56 storing the data representing the data length of the fields excluding the format type field 55 and the data length field 56 from the extended detailed timing information message 700.

(3) A reserved field 701 reserved for future use.

(4) An ID field 702 storing an ID number of the extended detailed timing information.

(5) An IP field 703 storing bit data representing whether the scanning method for video data is interlaced scanning or progressive scanning.

(6) A reserved field 704 reserved for future use.

(7) A refresh rate field 705 storing a value representing the refresh rate (field rate) of the video data in units of 0.01 Hz.

(8) An effective horizontal interval field 706 storing the number of effective pixels in the effective horizontal interval Hactive.

(9) An effective vertical interval field 707 storing the number of effective pixels in an effective vertical interval Vactive.

It is to be noted that each of the fields 705 to 707 has a size of 16 bits.

In the twelfth preferred embodiment, by extending the effective horizontal interval field 305 in the detailed timing information message 300 according to the first preferred embodiment, the detailed timing information of the 4k2k video format is transmitted. In addition, in the thirteenth preferred embodiment, by extending any of the fields 304, 305, 307, 309, 311, 313, 314, 315, 316, 317, 319, 321, 322, and 323 in the detailed timing information message 300 according to the first preferred embodiment, the detailed timing information of the 4k2k video format is transmitted. The present preferred embodiment is different from the twelfth and thirteenth preferred embodiments in that the extended detailed timing information format 700 is newly defined to notify from the sink device 120 to the source device 110 about each of the refresh rate, the number of effective pixels in the effective horizontal interval Hactive, and the number of effective pixels in the effective vertical interval Vactive, as 16-bit data. As shown in FIG. 36, each of the refresh rate of 4k2k video data, the number of effective pixels in the effective horizontal interval Hactive, and the number of effective pixels in the effective vertical interval Vactive can be represented by a 16-bit numeric value. Therefore, according to the present preferred embodiment, the refresh rate, the number of effective pixels in the effective horizontal interval Hactive, and the number of effective pixels in the effective vertical interval Vactive of the 4k2k video data can be transmitted from the sink device 120 to the source device 110.

### Fifteenth Preferred Embodiment

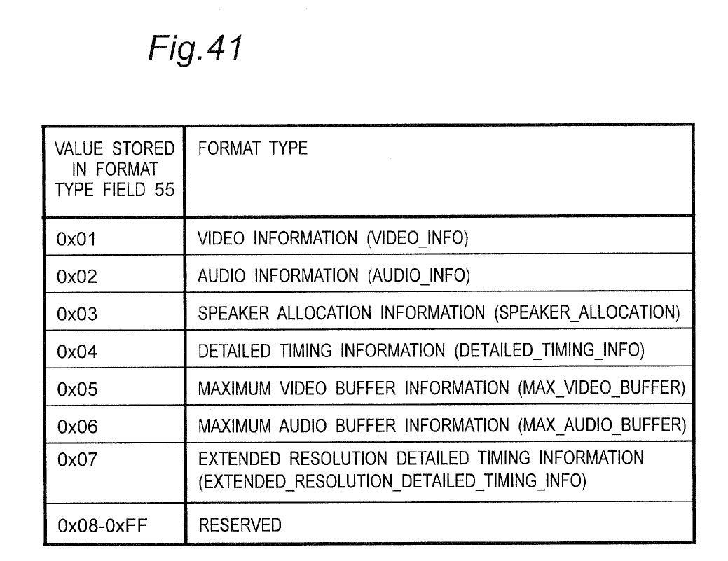

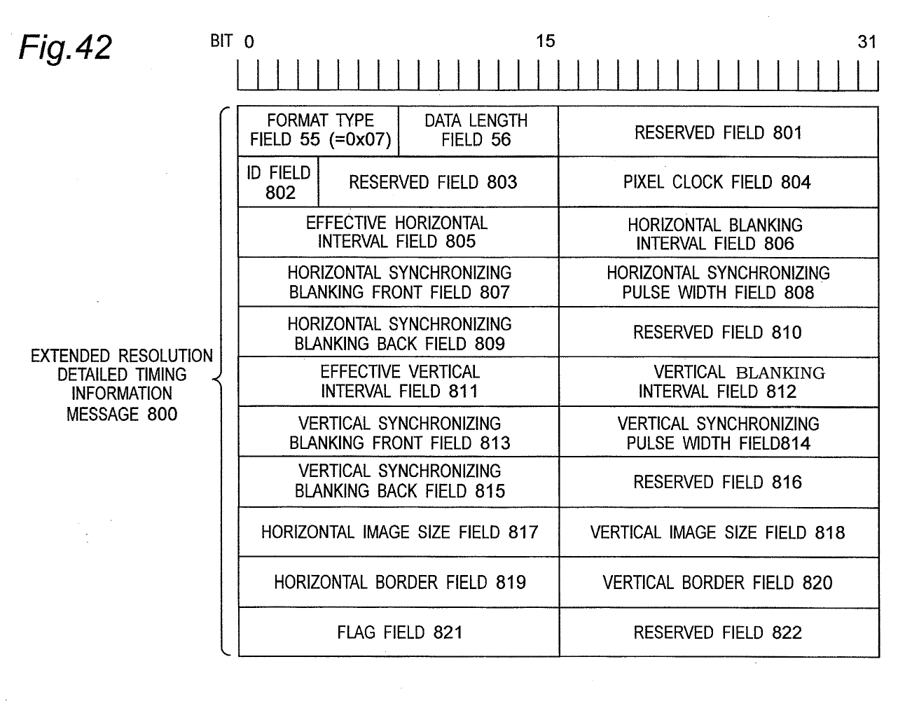

FIG. 41 is a table showing a relation between values stored in the format type field 55 in the input format information message 5 of FIG. 11, and format types in a fifteenth preferred embodiment of the present invention. In addition, FIG. 42 is a diagram showing a format of an extended resolution detailed timing information message 800 according to the fifteenth preferred embodiment of the present invention. Compared with the first preferred embodiment (See FIG. 12), as shown in FIG. 41, the present preferred embodiment is characterized in that, the value for the coded video information is deleted from data on format types stored in the format type field 55 in the input format information message 5, and a value (0x07) indicating extended resolution detailed timing information (EXTENDED_RESOLUTION_DETAILED_TIMING_INFO) is added. In this case, in the present preferred embodiment, a format data message 54 including the format type field 55 that stores the value (0x07) corresponding to the extended resolution detailed timing information is referred to as an extended resolution detailed timing information message 800.

Referring to FIG. 42, the extended resolution detailed timing information message 800 includes the following fields.

(1) The format type field 55 storing the value (0x07) corresponding to the extended resolution detailed timing information.

(2) The data length field 56 storing the data representing the data length of the fields excluding the format type field 55 and the data length field 56 from the extended resolution detailed timing information message 800.

(3) A reserved field 801 reserved for future use.

(4) An ID field 802 storing an ID number of the extended resolution detailed timing information.

(5) A reserved field 803 reserved for future use.

(6) A pixel clock field 804 storing the pixel clock frequency.

(7) An effective horizontal interval field 805 storing the number of effective pixels in the effective horizontal interval Hactive.

(8) A horizontal blanking interval field 806 storing the number of pixels in the horizontal blanking interval (blank interval) Hblank.

(9) A horizontal synchronizing blanking front field 807 storing a value representing a length of the horizontal synchronizing pulse front interval Hfront, by the number of pixels.

(10) A horizontal synchronizing pulse width field 808 storing a value representing a pulse width of the horizontal synchronizing pulse Hsync by the number of pixels.

(11) A horizontal synchronizing blanking back field 809 storing a value representing a length of the horizontal synchronizing pulse back interval Hback by the number of pixels.

(12) A reserved field 810 reserved for future use.

(13) An effective vertical interval field 811 storing the number of effective pixels in the effective vertical interval Vactive.

(14) A vertical blanking interval field 812 storing the number of pixels in the vertical blanking interval Vblank.

(15) A vertical synchronizing blanking front field 813 storing the value representing the length of the vertical synchronizing pulse front interval Vfront by the number of pixels.

(16) A vertical synchronizing pulse width field 814 storing the value representing the pulse width of a vertical synchronizing pulse Vsync by the number of pixels.

(17) A vertical synchronizing blanking back field 815 storing a value representing a length of the vertical synchronizing pulse back interval Vback by the number of pixels.

(18) A reserved field 816 reserved for future use.

(19) A horizontal image size field 817 storing the value representing the size of an image in the horizontal direction in millimeters.

(20) A vertical image size field 818 storing the value representing the size in of the image the vertical direction in millimeters.

(21) A horizontal border field 819 storing the data representing the border in the horizontal direction.

(22) A vertical border field 820 storing the data representing a border in the vertical direction.

(23) A flag field 821 storing the information on the stereo video.

(24) A reserved field 822 reserved for future use.

It is to be noted that each of the fields 804 to 822 has a size of 16 bits.

In the twelfth preferred embodiment, by extending the effective horizontal interval field 305 in the detailed timing information message 300 according to the first preferred embodiment, the detailed timing information of the 4k2k video format is transmitted. In addition, in the thirteenth preferred embodiment, by extending any of the fields 304, 305, 307, 309, 311, 313, 314, 315, 316, 317, 319, 321, 322, and 323 in the detailed timing information message 300 according to the first preferred embodiment, the detailed timing information of the 4k2k video format is transmitted. The present preferred embodiment is different from the twelfth and thirteenth preferred embodiments in that the extended resolution detailed timing information message 800 is newly defined to notify from the sink device 120 to the source device 110 about all of the timing information of video data as 16-bit data.

Therefore, according to the present preferred embodiment, since the sizes of the respective fields 804 to 821 that store timing information of video data are set to 16 bits, each of the fields 804 to 821 can store any value from 0 to 65535. Therefore, as shown in FIG. 36, all of the detailed timing information of the 4k2k video data can be transmitted from the sink device 120 to the source device 110.

It is to be noted that, in the present preferred embodiment, compared with the first preferred embodiment (See FIG. 12), the value for the coded video information is deleted from the data on the format types stored in the format type field 55 in the input format information message 5, and the value (0x07) indicating the extended resolution detailed timing information is added. However, the present invention is not limited to this. Compared with the first preferred embodiment (See FIG. 12), without deleting the value for the coded video information from the data on the format types stored in the format type field 55 in the input format information message 5, a value (e.g., 0x08) indicating the extended resolution detailed timing information may be added.

### Sixteenth Preferred Embodiment

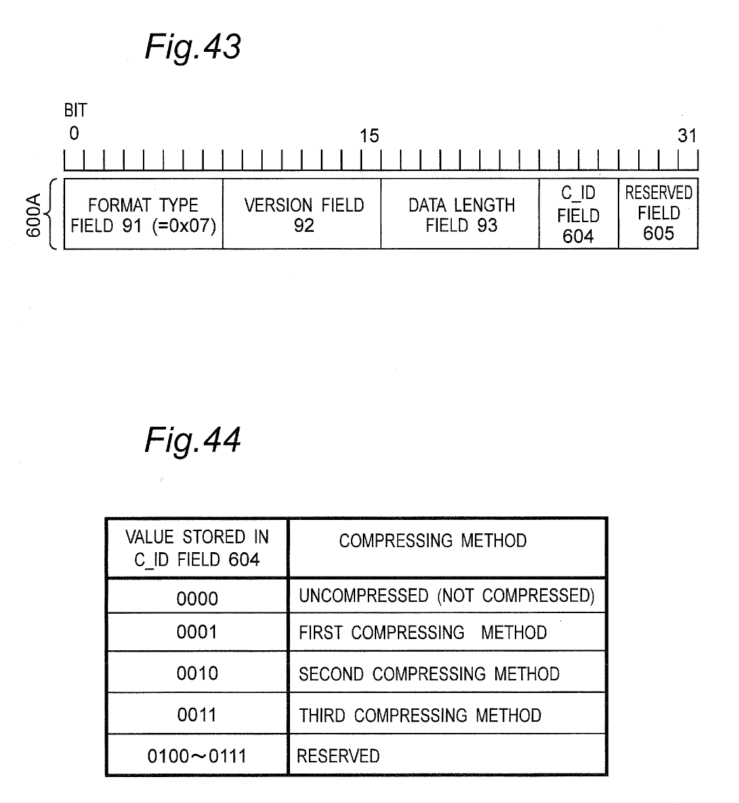

FIG. 43 is a diagram showing a coded video format field 600A according to a sixteenth preferred embodiment of the present invention. In addition, FIG. 44 is a table showing a relation between values stored in a C_ID field 604 of FIG. 43, and compressing methods. Referring to FIG. 43, the coded video format field 600A includes the following fields.

(1) The format type field 91 storing the value (0x07) corresponding to the coded video information.

(2) The version field 92 storing the version number 0x01.

(3) The data length field 93 storing the data representing the total data length of the following fields 604 and 605.

(4) The C_ID field 604 storing a value defined in FIG. 44 and indicating a compressing method for video data to be transmitted.

(5) The reserved field 605 reserved for future use.

As compared with the first preferred embodiment, the source device 110 according to the present preferred embodiment transmits the stream start notify message 8 including the coded video format field 600A instead of the coded video format field 600, to the sink device 120. In this case, the source device 110 stores a value indicating a compressing method for video data to be transmitted, in the C_ID field 604. The sink device 120 receives the stream start notify message 8. Based on the C_ID field 604 in the received stream start notify message 8, the sink device 120 previously identifies, which one of uncompressed video data, compressed video data compressed by the first compressing method, compressed video data compressed by the second compressing method, and compressed video data compressed by the third compressing method is to be transmitted from the source device 110.

Therefore, according to the present preferred embodiment, the source device 110 can notify the sink device 120 of a compressing method for the video data to be transmitted, by transmitting the stream start notify message 8 including the coded video format field 600A to the sink device 120.

### Seventeenth Preferred Embodiment

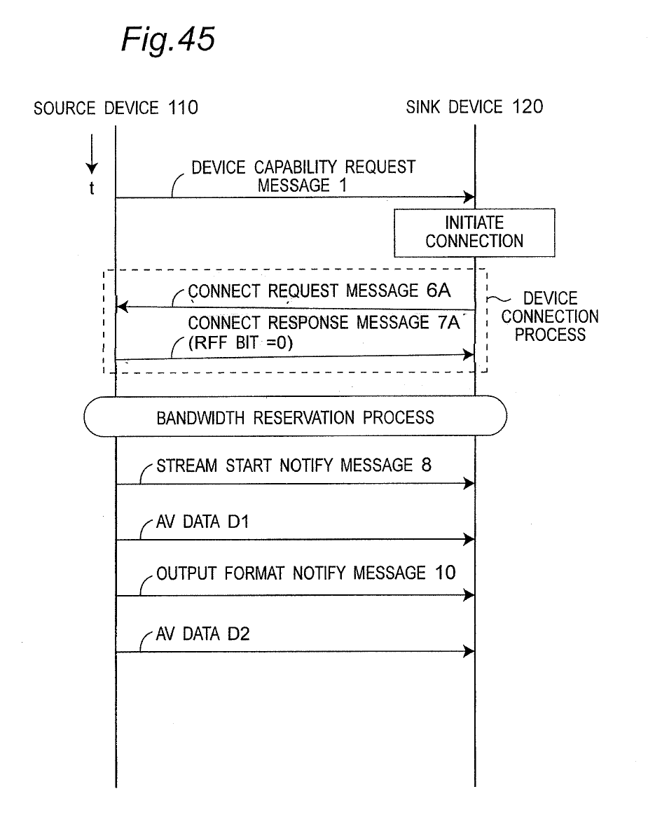

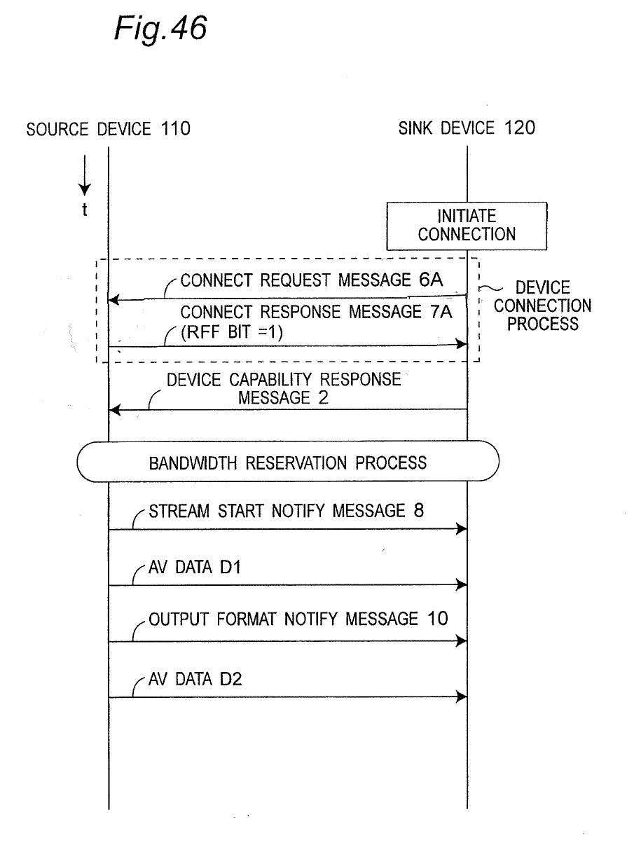

FIG. 45 is a sequence diagram showing a device connection process according to a seventeenth preferred embodiment of the present invention, where the device connection process is initiated by the sink device 120 and the source device 110 does not request the sink device 120 for format information. In addition, FIG. 46 is a sequence diagram showing a device connection process according to the seventeenth preferred embodiment of the present invention, where the device connection process is initiated by the sink device 120 and the source device 110 does not request the sink device 120 for the format information. The present preferred embodiment is characterized in that, compared with the first preferred embodiment, the sink device 120 initiates a device connection process.

When the sink device 120 initiates the device connection process, the sink device 120 sends a connect request message 6A which includes the sink port number to the source device 110 to notify the source device 110 of the sink port number and to request the source device 110 to reserve the source port and bandwidth for AV data transmission. In this case, the S bit included in the connect request message 6A is set to one and a port field included in the connect request message 6A contains the sink port number.

As shown in FIG. 45, when, before the device connection process, the sink device 120 receives the device capability request message 1 from the source device 110 and the FC bit in the device capability request message 1 is set to 1, the sink device 120 previously identifies that the source device 110 supports a fast connect sequence, before the device connection process. In this case, the sink device 120 adds supported formats of the sink device 120 into the connect request message 6A. Namely, in a manner similar to that of the device capability response message 2 of FIG. 9, the connect request message 6A includes the input format information message 5 including the video information message 200, the detailed timing information message 300 and the coded video information message 400, and the device information message 3. On the other hand, referring to FIG. 45, when, before the device connection process, the sink device 120 receives the device capability request message 1 from the source device 110 and the FC bit in the device capability request message 1 is set to 0, the sink device 120 previously identifies that the source device 110 does not support the fast connect sequence before the device connection process. In this case, the sink device 120 stores zero in the total data length field in the connect request message 6A.

After the source device 110 receives the connect request message 6A, the source device 110 reserves the source port for AV data transmission with a sink port if the source device 110 accepts the connection request from the sink device 120. After the source device 110 successfully completes a source port reservation process, the source device 110 sends a connect response message 7A including a result code field that stores data representing “Success” to the sink device 120 and performs the bandwidth reservation process. In addition, if the source device 110 requested the sink device 120 for information on the supported formats, as shown in FIG. 46, the source device 110 sets the RF bit in the connect response message 7A to 1. When the RF bit in the connect response message 7A is set to 1, the sink device 120 transmits the device capability response message 2 including information on formats supported by the sink device 120, to the source device 110.

It is to be noted that if the source device 110 rejects the connection request from the sink device 120, the source device 110 stores data representing “Failure” with the appropriate reason in the result code field in the connect response message 7A.

Further, when the source device 110 successfully completes the bandwidth reservation process, the source device 110 sends the stream start notify message 8 including the result code field 82 that stores data representing “Success” to the sink device 120. On the other hand, when the source device 110 fails the bandwidth reservation process, the source device 110 sends the stream start notify message 8 including the result code field 82 that stores data representing “Failure” to the sink device 120. Once an HRP stream is allocated, the source device 110 wirelessly transmits HRP packets with only the PHY and MAC header to the sink device 120 until the source device 110 receives an ACK signal from the sink device 120, which indicates that the sink device 120 ready to receive the HRP packets with data for an HRP stream. After the source device 110 receives the ACK signal, the source device 110 inserts AV data into the HRP packets and wirelessly transmits the HRP packets to the sink device 120.

The present preferred embodiment has advantageous action and effects similar to those in the first preferred embodiment.

### Eighteenth Preferred Embodiment

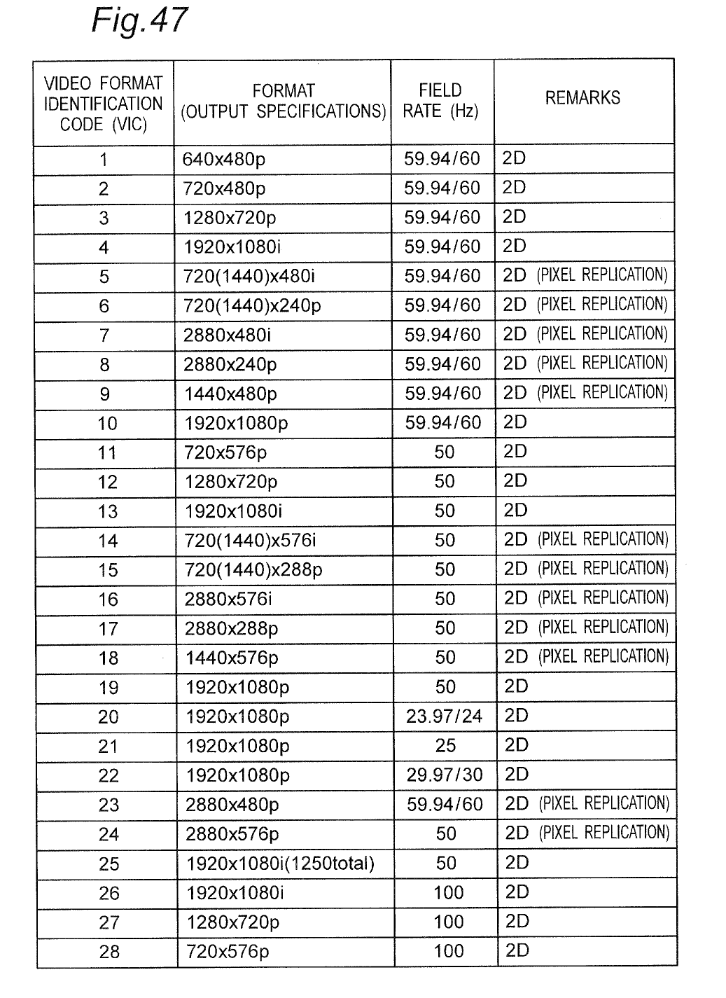

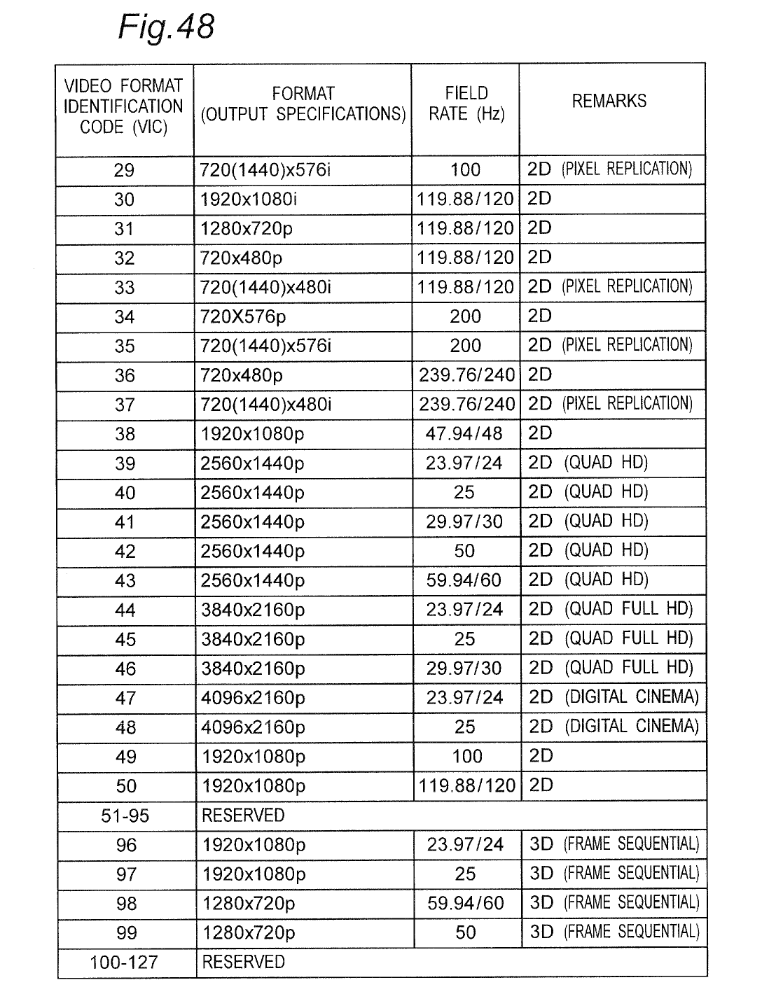

FIGS. 47 and 48 are tables showing VIC tables 115t and 127t according to an eighteenth preferred embodiment of the present invention. The present preferred embodiment is different from the first preferred embodiment in only how to assign VICs. In the present preferred embodiment, VICs 44 to 48 are assigned to the 4k2k video formats as follows.

(a) VIC of 44 is assigned to a 4k2k video format having 3840 effective horizontal pixels, 2160 effective vertical pixels, the progressive scanning method, and a field rate of 23.97 Hz or 24 Hz.

(b) VIC of 45 is assigned to a 4k2k video format having 3840 effective horizontal pixels, 2160 effective vertical pixels, the progressive scanning method, and a field rate of 25 Hz.

(c) VIC of 46 is assigned to a 4k2k video format having 3840 effective horizontal pixels, 2160 effective vertical pixels, the progressive scanning method, and a field rate of 29.97 Hz or 30 Hz.

(d) VIC of 47 is assigned to a 4k2k video format having 4096 effective horizontal pixels, 2160 effective vertical pixels, the progressive scanning method, and a field rate of 23.97 Hz or 24 Hz.

(e) VIC of 48 is assigned to a 4k2k video format having 4096 effective horizontal pixels, 2160 effective vertical pixels, the progressive scanning method, and a field rate of 25 Hz.

The present preferred embodiment has advantageous action and effects similar to those in the first preferred embodiment.

It is to be noted that each of the formats of the respective messages shown in the above-described preferred embodiments is merely an example and thus the arrangement order and sizes of fields, etc., may be changed as long as fields similar to above are included in a message.

In addition, although in the above-described preferred embodiments, the bandwidth management unit 121b is provided in the sink device 120, however, the present invention is not limited to this. The bandwidth management unit 121b may be provided in the source device 110 or other devices.

In addition, although in the above-described preferred embodiments, the VIC table shown in FIGS. 2 to 4 or the VIC table shown in FIGS. 47 and 48 is used, however, the present invention is not limited to this. The VIC table can be any as long as the VIC table includes VICs that identify the 4k2k video formats.

### INDUSTRIAL APPLICABILITY

As described above in detail, according to a method of transmitting video data, a source device for transmitting the video data, a sink device for receiving the video data, and a wireless communication system including the source device and the sink device, according to the present inventions, the sink device wirelessly transmits a device capability response message to the source device. In this case, the device capability response message includes a video information message including at least one video format identification code for identifying a video format of video data that can be displayed on the sink device, and (b) a coded video information message including compressing parameters for compressing video data. On the other hand, the source device wirelessly transmits a stream start notify message to the sink device, and thereafter, wirelessly transmits first video data to the sink device. In this case, the stream start notify message includes a video format identification code for identifying a video format of the first video data to be transmitted, and data representing whether or not the first video data is compressed. The video format identification code for identifying the video format of the first video data is selected from among at least one video format identification code for 4k2k video data having 3840 or 4096 effective horizontal pixels and 2160 effective vertical pixels. Therefore, 4k2k video data can be wirelessly transmitted.

### REFERENCE SIGNS LIST

1 . . . device capability request message;
2 . . . device capability response message;
3 . . . device information message;
5 . . . input format information message;
6 and 6a . . . connect request message;
7 and 7a . . . connect response message;
8 . . . stream start notify message;
10 . . . output format notify message;
110 . . . source device;
111 . . . controller;
112 . . . audio and visual reproducing device;
113 . . . packet processing circuit;
114 . . . packet wireless transceiver circuit;
115 . . . memory;
115t . . . VIC table;
116 . . . antenna;
120 . . . sink device;
121 . . . controller;
121b . . . bandwidth management unit;
122 . . . packet wireless transceiver circuit;
123 . . . packet processing circuit;
124 . . . audio and visual processing circuit;
125 . . . loudspeaker;
126 . . . display;
127 . . . memory;
127d . . . EDID data;
127t . . . VIC table;
129 . . . buffer;
200 . . . video information message;
300, 300a, and 300b . . . detailed timing information message;
400 and 400a to 400j . . . coded video information message;
500 . . . video format field;
600 and 600a . . . coded video format field;
700 . . . extended detailed timing information message; and
800 . . . extended resolution detailed timing information message.

1-9. (canceled)

10. A sink device for a wireless communication system for wirelessly transmitting video data from a source device to the sink device,
wherein the sink device comprises a first controller for wirelessly transmitting a device capability response message to the source device, the device capability response message including (a) a video information message including at least one video format identification code for identifying a video format of video data, which the sink device can display, and (b) a coded video information message including compressing parameters for compressing video data, and
wherein the at least one video format identification code includes at least one video format identification code for 4k2k video data having 3840 or 4096 effective horizontal pixels and 2160 effective vertical pixels.

11. The sink device as claimed in claim 10,
wherein the source device wirelessly transmits a stream start notify message to the sink device, and thereafter, wirelessly transmits first video data to the sink device, the stream start notify message including a video format identification code for identifying a video format of the first video data to be transmitted, and data representing whether or not the first video data is compressed,
wherein the first controller wirelessly receives the stream start notify message from the source device, and identifies the video format identification code of the first video data and whether or not the first video data is compressed, based on wirelessly received stream start notify message,
wherein the first controller wirelessly receives the first video data, and
wherein the first controller decompresses the first video data and decodes decompressed first video data based on an identified video format identification code when the first video data is compressed, and decodes the first video data based on the identified video format identification code when the first video data is not compressed.

12. The sink device as claimed in claim 11,
wherein, when the video format of the first video data is changed, the source device wirelessly transmits an output format notify message to the sink device, and thereafter, wirelessly transmits second video data having a changed video format to the sink device, the output format notify message including a video format identification code for identifying the changed video format, and data representing whether or not the second video data is compressed,
wherein the first controller wirelessly receives the output format notify message from the source device, and identifies the video format identification code of the second video data and whether or not the second video data is compressed, based on wirelessly received output format notify message,
wherein the first controller wirelessly receives the second video data, and
wherein the first controller decompresses the second video data and decodes decompressed second video data based on an identified video format identification code when the second video data is compressed, and decodes the second video data based on the identified video format identification code when the second video data is not compressed.

13. A source device for a wireless communication system for wirelessly transmitting video data from the source device to a sink device,
wherein the source device comprises a second controller for wirelessly transmitting a stream start notify message to the sink device, and thereafter, wirelessly transmitting first video data to the sink device, the stream start notify message including a video format identification code for identifying a video format of the first video data to be transmitted, and data representing whether or not the first video data is compressed, and
wherein the video format identification code for identifying the video format of the first video data is selected from among at least one video format identification code for 4k2k video data having 3840 or 4096 effective horizontal pixels and 2160 effective vertical pixels.

14. The source device as claimed in claim 13,
wherein the second controller wirelessly receives a device capability response message from the sink device, the device capability response message including (a) a video information message including at least one video format identification code for identifying a video format of video data, which the sink device can display, and (b) a coded video information message including compressing parameters for compressing video data, and
wherein the second controller selects one video format identification code from among the video format identification code included in the device capability response message, generates the first video data based on a selected video format identification code, compresses a generated first video data using the compressing parameters, and wirelessly transmits compressed first video data to the sink device.

15. The source device as claimed in claim 14,
wherein, when the video format of the first video data is changed, the second controller wirelessly transmits an output format notify message to the sink device, and thereafter, wirelessly transmits second video data having a changed video format to the sink device, the output format notify message including a video format identification code for identifying the changed video format, and data representing whether or not the second video data is compressed.

16. A wireless communication system for wirelessly transmitting video data from a source device to a sink device, the wireless communication system comprising the source device and the sink device,
wherein the sink device comprises a first controller for wirelessly transmitting a device capability response message to the source device, the device capability response message including (a) a video information message including at least one video format identification code for identifying a video format of video data, which the sink device can display, and (b) a coded video information message including compressing parameters for compressing video data,
wherein the at least one video format identification code includes at least one video format identification code for 4k2k video data having 3840 or 4096 effective horizontal pixels and 2160 effective vertical pixels,
wherein the source device comprises a second controller for wirelessly transmitting a stream start notify message to the sink device, and thereafter, wirelessly transmitting first video data to the sink device, the stream start notify message including a video format identification code for identifying a video format of the first video data to be transmitted, and data representing whether or not the first video data is compressed, and
wherein the video format identification code for identifying the video format of the first video data is selected from among the at least one video format identification code.

17. A video data transmission method of wirelessly transmitting video data from a source device to a sink device, the method including the following steps of:
by the sink device, wirelessly transmitting a device capability response message to the source device, the device capability response message including (a) a video information message including at least one video format identification code for identifying a video format of video data, which the sink device can display, and (b) a coded video information message including compressing parameters for compressing video data;
by the source device, wirelessly receiving the device capability response message, selecting one video format identification code from among the video format identification code included in the device capability response message, generating first video data based on a selected video format identification code, and compressing generated first video data using the compressing parameters;
by the source device, wirelessly transmitting a stream start notify message to the sink device, and thereafter, wirelessly transmitting compressed first video data to the sink device, the stream start notify message including the selected video format identification code, and data representing whether or not the first video data is compressed;
by the sink device, wirelessly receiving the stream start notify message, and identifying the video format identification code of the first video data and whether or not the first video data is compressed, based on wirelessly received stream start notify message; and
by the sink device, wirelessly receiving the first video data, and decompressing the first video data and decoding decompressed first video data based on an identified video format identification code when the first video data is compressed, and decoding the first video data based on the identified video format identification code when the first video data is not compressed,
wherein the at least one video format identification code includes at least one video format identification code for 4k2k video data having 3840 or 4096 effective horizontal pixels and 2160 effective vertical pixels.

18. The video data transmission method as claimed in claim 17, further including the following steps of:
when the video format of the first video data is changed, by the source device, wirelessly transmitting an output format notify message to the sink device, and thereafter, wirelessly transmitting second video data having a changed video format to the sink device, an output format notify message including a video format identification code for identifying the changed video format, and data representing whether or not the second video data is compressed;
by the sink device, wirelessly receiving the output format notify message, and identifying the video format identification code of the second video data and identifying whether or not the second video data is compressed, based on a wirelessly received output format notify message; and
by the sink device, wirelessly receiving the second video data; and
by the sink device, decompressing the second video data and decoding decompressed second video data based on an identified video format identification code when the second video data is compressed, and decoding the second video data based on the identified video format identification code when the second video data is not compressed.
